(19) United States
(12) Patent Application Publication
(10) Pub. No.: US 2025/0200392 A1
(43) Pub. Date: Jun. 19, 2025

(54) LARGE LANGUAGE MODEL VERIFICATION

(71) Applicant: Amazon Technologies, Inc., Seattle, WA (US)

(72) Inventors: Michael William WHALEN, Edina, MN (US); Benjamin KIESL-REITER, Munich (DE); Nadia LABAI, Redmond, WA (US); John Byron COOK, Brooklyn, NY (US)

(21) Appl. No.: 18/541,988

(22) Filed: Dec. 15, 2023

(51) Int. Cl. G06N 5/01; G06N 5/04

(52) U.S. Cl. CPC G06N 5/013; G06N 5/04

(57) ABSTRACT

Verifying large language model responses involves obtaining a query and its corresponding answer from a large language model. This conversational text is then fed into a second large language model, which translates the answer into first-order logic. The verification process uses an automated theorem prover. It checks the validity of this logic translation by determining the unsatisfiability of two scenarios: one where the negation of the logic translation and domain-specific logic formulas are combined, and another where the logic translation itself is combined with these formulas. Based on this analysis, the theorem prover ascertains whether the translated answer is valid, invalid, or neither. The final step is communicating this verification status through an appropriate output medium, such as a graphical user interface, a database, or a report, providing a structured and methodical approach to assessing the accuracy and reliability of language model responses.

### BACKGROUND

A large language model, or “LLM,” is a type of artificial intelligence system designed to understand, generate, and interact with human language. LLMs are based on a neural network architecture known as a transformer. Transformers enable LLMs to analyze and process vast amounts of text data. An LLM is “trained” through a process called machine learning, where a large corpus of text from various sources is input to the model. During training, the model learns patterns, language structures, and nuances, allowing it to generate coherent, contextually relevant responses. This learning process involves adjusting the internal parameters of the model to minimize the difference between its outputs and the expected results. Once trained, the model can perform a wide range of language-related tasks, such as answering questions, translating languages, summarizing texts, and creating content.

LLMs are known to “hallucinate.” Large Language Model (LLM) hallucinations refer to instances where these models generate incorrect, misleading, or nonsensical information while appearing confident and coherent. This phenomenon arises because LLMs don't truly “understand” content in the way humans do. Instead, they generate responses based on patterns learned from their training data. When an LLM encounters a query that falls outside its training or is ambiguous, it can produce responses that seem plausible but are factually inaccurate or completely fabricated. This issue is compounded by the model's lack of real-world awareness and inability to access or verify current information beyond its training cutoff. LLM hallucinations pose a challenge in applications where accuracy is crucial, as the model's authoritative tone can be misleading.

### BRIEF DESCRIPTION OF THE DRAWINGS

The detailed description of certain embodiments of the invention below may be understood by reference to the following figures:

FIG. 1 illustrates a Large Language Model (LLM) verifier system that enhances the accuracy of the outputs of a vanilla LLM and includes a domain model creator subsystem and an answer verifier subsystem.

FIG. 2 illustrates the domain model creator subsystem and detailed operation thereof.

FIG. 3 illustrates the answer verifier subsystem and detailed operation thereof.

FIG. 4 illustrates an example conversation between a user and a large language model (LLM) agent.

FIG. 5 is flowchart of a method for selecting a desired translation of natural language to logic.

FIG. 6 illustrates three procedures implementing a scenario generation technique.

FIG. 7 is a flowchart of an enumerate models procedure of the scenario generation technique.

FIG. 8 is a flowchart of a minimize model procedure of the scenario generation technique.

FIG. 9 illustrates an example multi-tenant provider network environment in which the techniques disclosed herein for large language model (LLM) verification may be implemented.

FIG. 10 is a block diagram of an example multi-tenant provider network that provides a storage service and a hardware virtualization service to customers and in which the techniques disclosed herein for large language model (LLM) verification may be implemented.

FIG. 11 illustrates an example of a programmable electronic device that processes and manipulates data to perform tasks and calculations disclosed herein for large language model (LLM) verification.

### DETAILED DESCRIPTION

Disclosed herein are systems, methods, and non-transitory computer-readable media (generally, “techniques”) for large language model (LLM) verification. The techniques include verifying large language model responses by obtaining a query and its corresponding answer from a large language model. This conversational text is then fed into a second large language model, which translates the answer into first-order logic. The verification process uses an automated theorem prover. It checks the validity of this logic translation by determining the unsatisfiability of two scenarios: one where the negation of the logic translation and domain-specific logic formulas are combined, and another where the logic translation itself is combined with these formulas. Based on this analysis, the theorem prover ascertains whether the translated answer is valid, invalid, or neither. The final step is communicating this verification status through an appropriate output medium, such as a graphical user interface, a database, or a report, providing a structured and methodical approach to assessing the accuracy and reliability of language model responses.

The present disclosure includes a structured approach to verify responses generated by large language models. It begins by collecting a query and its answer from a primary large language model. This conversational exchange is then processed by a secondary large language model that translates the answer into first-order logic. This translation forms the basis of the verification process, which is conducted using an automated theorem prover. The theorem prover evaluates the logical validity by examining two distinct scenarios. In the first scenario, it checks the unsatisfiability of the negated logic translation in conjunction with domain-specific logic formulas. In the second, it assesses the unsatisfiability of the direct logic translation combined with the same set of formulas. This dual analysis allows the theorem prover to determine if the translated answer is valid, invalid, or indeterminate. Finally, the outcome of this verification is communicated through an output medium like a graphical user interface, a database, or a report. This approach ensures a rigorous and systematic evaluation of the accuracy and reliability of answers provided by language models, enhancing their credibility and utility in various applications.

As referenced in this description, large language models (LLMs) are advanced AI systems characterized by their deep learning techniques and vast training datasets. They are built using neural networks, specifically a type of architecture known as the Transformer, which is highly efficient in processing and generating sequential data like text. The “large” in their name refers not only to the size of their training data, encompassing diverse text sources, but also to the complexity of their neural network, often containing billions or even trillions of parameters. These parameters are fine-tuned during the training process, allowing the model to learn intricate patterns and nuances of language, including grammar, context, idioms, and even styles of writing. A useful feature of large language models is their ability to handle and generate contextually relevant text, making them adept at tasks like answering questions, composing texts, and translating languages. They achieve this through a mechanism known as attention, which enables the model to weigh different parts of the input text differently, thereby focusing on the most relevant parts to generate coherent and context-aware outputs.

In this disclosure, familiarity with first-order logic is assumed. Formulas of a first-order language L are built using predicate symbols, function symbols, and constants from some given alphabet together with logical connectives, quantifiers, and variables. An expression (e.g., a term, literal, formula, etc.) is ground if it contains no variables. A propositional assignment is a mapping from ground atoms to the truth values 1 (true) and 0 (false). Accordingly, a set of ground formulas is propositionally satisfiable if there exists a propositional assignment that satisfies all formulas in the set under the usual semantics for the logical connectives. Assignments can be written as sequences of literals where a positive (negative) polarity of a literal indicates that the truth value 1 (0, respectively) is assigned to the literal's atom.

As referenced in this description, automated theorem provers are sophisticated computational tools designed to assist in or fully automate the process of proving mathematical theorems. At their core, they rely on formal logic and various algorithms to deduce truths from a set of axioms and rules of inference. These systems are built upon a foundation of symbolic logic, primarily using first-order or higher-order logic. The technical prowess of these provers lies in their ability to methodically explore the vast space of potential proofs, which is often too large and complex for manual navigation. They employ various strategies like resolution, term rewriting, and decision procedures for specific theories to efficiently manage this exploration. Some provers specialize in certain domains by incorporating relevant mathematical theories (like arithmetic or geometry), thereby enhancing their effectiveness in those areas. A useful aspect of automated theorem provers is their use of formal languages to ensure precision and unambiguity in representing mathematical statements. This precision is crucial for correctly interpreting the theorems and proofs.

As referenced in this description, an SMT (Satisfiability Modulo Theories) solver, as a type of automated theorem prover, is distinguished by its ability to determine the satisfiability of logical formulas within various mathematical theories. Technically, it extends the capabilities of a basic SAT (Boolean satisfiability) solver by incorporating domain-specific knowledge from theories like linear arithmetic, real numbers, bit-vectors, arrays, and function symbols with uninterpreted functions. This integration allows SMT solvers to handle a more expressive set of logical formulas than those limited to propositional logic.

A useful characteristic of SMT solvers is their use of decision procedures or theory solvers, specialized algorithms designed to handle formulas within a specific theory. These solvers can efficiently reason about the satisfiability of formulas by considering the semantics of the theories they involve. An SMT solver typically integrates multiple theory solvers, enabling it to work with formulas that span several theories simultaneously. This feature makes SMT solvers incredibly versatile and powerful, especially in applications like software verification, model checking, and constraint solving, where complex logical relationships need to be analyzed.

The effectiveness of an SMT solver largely depends on its ability to balance the generality of handling multiple theories with the efficiency of solving instances quickly. It achieves this through techniques like backtracking, theory combination, and heuristic-guided search.

As referenced in this description, SMT-LIB is a standard library for Satisfiability Modulo Theories (SMT), designed to facilitate the development, testing, and comparison of SMT solvers. It primarily consists of a large and growing collection of benchmark problems, expressed in a standardized input language. This language, also called SMT-LIB language, is a formal, computer-readable language specifically crafted for describing problems in various SMT theories like linear integer arithmetic, real arithmetic, bit-vectors, arrays, and uninterpreted functions. The language is rigorously defined, ensuring consistency and uniformity in the way SMT problems are specified, which is crucial for fair and accurate comparisons among different solvers.

One of the useful technical characteristics of SMT-LIB is its structured, yet flexible format. It allows for the clear definition of logic theories, the declaration of functions and types, and the specification of assertions (formulas) that need to be satisfied. This structured approach enables SMT solvers to parse and process these benchmarks uniformly. SMT-LIB also provides a common set of commands for solver interaction, making it easier to control and communicate with SMT solvers in a standardized way.

### Example LLM Verification System

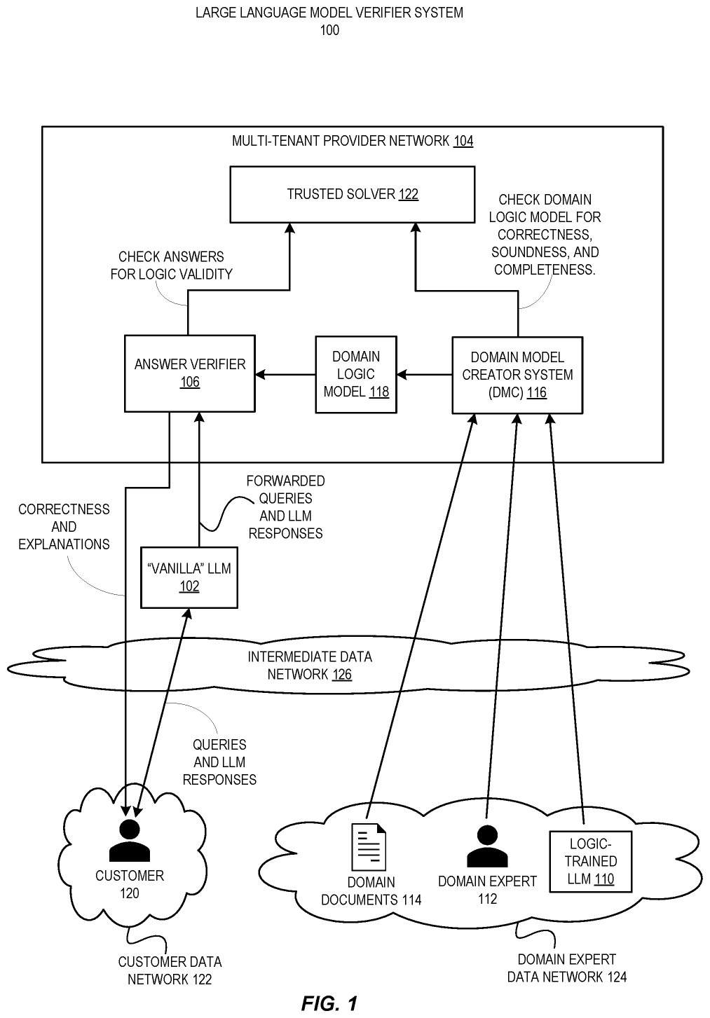

Referring now to FIG. 1, a Large Language Model (LLM) verifier system 100 enhances the accuracy of the outputs of a “vanilla” LLM 102. The vanilla LLM 102 can be a standard, general-purpose LLM used for basic language processing and interaction tasks. However, the techniques described herein can be implemented with a special-purpose LLM as a substitute for the vanilla LLM 102 where the special-purpose LLM is based on a vanilla LLM or a foundational LLM that has been fine-tuned or trained for a domain-specific task using, for example, retrieval augmented generation (RAG) techniques or other suitable LLM fine-tuning techniques.

The enhancement in accuracy is achieved by verifying the truthfulness of the key information that the vanilla LLM 102 provides in response to customer queries. The LLM verifier system 100 is designed with multiple interconnected networks, each contributing to this verification process. A multi-tenant provider network 104, which includes an answer verifier system 106, or “answer verifier 106,” acts as a primary checkpoint for validating responses. The answer verifier system 106 cross-references the vanilla LLM 102's answers with trusted sources or logical frameworks, ensuring that the information is not only coherent but also factually correct. Meanwhile, domain expert data network 108, which encompasses a logic-trained LLM 110, a domain expert 112, and a set of documents 114, offers specialized oversight.

Ensuring the accuracy of certain types of information generated by the vanilla LLM 102 is important. This is especially true for data that is critically sensitive, high-stakes, or foundational to subsequent decision-making processes. In such scenarios, it is important to minimize or mitigate what are known as “LLM hallucinations” by the vanilla LLM 102. An LLM hallucination occurs when the model generates responses that are confidently presented but factually incorrect or nonsensical. This can be particularly problematic when dealing with sensitive or critical information where accuracy is non-negotiable. To address this, the LLM verifier system 100 employs rigorous verification mechanisms, such as cross-referencing with trusted data sources, logical consistency checks, and specialized domain expertise, to ensure that the outputs from the vanilla LLM 102 are not only plausible but also factually accurate. This layered approach to verification is useful to maintaining the integrity and reliability of subsequent decision making, especially in scenarios where incorrect information could lead to significant consequences.

The LLM verifier system 100 serves as a “source of truth” for critical domains, striking a balance between automation and human curation. The LLM verifier system 100 is designed to automate the process of verifying the accuracy and reliability of information generated by the vanilla LLM 102, especially in areas where precision is paramount. The automated aspect is facilitated by advanced algorithms and logical models within the LLM verifier system 100, which cross-check the vanilla LLM 102's outputs against a robust database of verified information and domain-specific knowledge. This process ensures that the responses are not only contextually relevant but also factually correct. However, there may be an element of human curation involved as well. The domain expert 112 oversees and refines the LLM verified system 100's outputs, particularly in complex or nuanced areas where human judgement is crucial. This combination of automated verification with expert oversight enables the LLM verifier system 100 to function as a reliable and authoritative source in critical domains, providing customers with confidence in the accuracy and integrity of the information they receive.

In operation, a domain model creator system 116, or just “DMC 116,” accepts as input the set of documents 114 containing critical information. These documents 114 are not just random assortments of information; they are carefully selected and contain critical information pertinent to the domain or subject matter at hand. For example, the documents 114 can pertain to laws, rules, regulations, or health and safety, etc. For example, these documents 114 may include detailed information about laws, encompassing statutes, legal precedents, and legislative texts. They could also cover various rules and regulations that govern industry practices, corporate behavior, or public policies. Additionally, these documents 114 might encompass data related to health and safety, such as medical guidelines, public health protocols, safety standards in manufacturing, or environmental protection regulations.

The DMC 116 uses the documents 114 to create a domain model in logic (referred to as “domain logic model 118”) that is used by the answer verifier 106 to verify responses generated by the vanilla LLM 102 to prompts submitted to the vanilla LLM 102 by a customer 120. The domain logic model 118 is specifically tailored to enhance the functionality of the vanilla LLM 102. When the customer 120 submits prompts to the vanilla LLM 102, it generates responses based on its general knowledge and algorithms. However, the accuracy and relevance of these responses, especially in specialized or complex domains, may not always be optimal. This is where the domain logic model 118 created by the DMC 116 becomes useful. It acts as a verifier or a benchmark against which the responses from the vanilla LLM 102 are evaluated. The logic model 118, informed and structured by the critical information in the documents 114, embodies a logical and domain-specific understanding. This allows it to assess the vanilla LLM 102's responses for their accuracy and alignment with the specialized knowledge encapsulated in the domain logic model 118. Essentially, the DMC 116, in conjunction with the domain logic model 118 and the answer verifier 106, imparts an additional layer of expertise and validation to the outputs of the vanilla LLM 102, ensuring that the information provided to the customer 120 is not only generated by advanced AI algorithms but is also vetted against the robust, logically constructed domain logic model 118.

To verify responses generated by the vanilla LLM 102 against domain logic model 118, the responses are transformed into formal logic for accuracy. This means that the responses, initially in a natural language format, are converted into a structured, logical form. This transformation is useful to assessing the accuracy of the responses. By expressing the responses in the language of formal logic, it becomes possible to rigorously compare them against the established principles and rules encapsulated in the domain logic model 118. The domain logic model 118 acts as a benchmark, embodying the specific logical constructs and knowledge pertinent to the domain in question. Therefore, when the vanilla LLM 102's responses are converted into this formal logical structure, it allows for a systematic and precise evaluation. This process ensures that the responses not only seem plausible in natural language but also adhere to the stringent criteria of logical coherence and factual accuracy as defined by the domain logic model 118. This verification step is useful for maintaining the integrity and reliability of the vanilla LLM 102's outputs, especially in scenarios where precision and correctness are paramount.

The DMC 116 creates the domain logic model 118 from the documents 114 with the aid of a logic-trained LLM 110. The logic-trained LLM 110 can be a vanilla or generic LLM that has been fined-tuned or enhanced using retrieval augmented generation (RAG) techniques. The logic-trained LLM 110 is trained on logical syntax, and examples of rules specified in the documents 114 converted to logic. The logic-trained LLM 110 starts as a vanilla or generic LLM, which is then fine-tuned or enhanced through the application of Retrieval Augmented Generation (RAG) techniques. These techniques enable the logic-trained LLM 110 to incorporate and leverage external information effectively, enhancing its capability to process and understand complex data. An aspect of the logic-trained LLM 110 is its training regimen; it is specifically trained on logical syntax and examples of rules that are extracted from the set of documents 114. These rules and related information from the documents are converted into a formal logic structure as part of the training process. This specialized training ensures that the logic-trained LLM 110 has a robust understanding of logical constructs and is adept at handling and interpreting information in a logically coherent manner. Consequently, when the DMC 116 employs this logic-trained LLM 110 to assist in creating the domain logic model 118, it benefits from the logic-trained LLM 110's enhanced ability to process and integrate complex, rule-based information. This results in the formation of a highly sophisticated and accurate domain logic model 118, which is then used to verify and validate responses in specific domain contexts, ensuring their logical soundness and adherence to the specialized knowledge encapsulated in the documents.

In some embodiments, the domain expert 112 uses the logic-trained LLM 110 through a series of pre-built prompt templates to derive the domain logic model 118 in a logic specification format from the set of documents 114. In this scenario, the domain expert 112 utilizes the logic-trained LLM 110, but rather than engaging in an open-ended or ad-hoc interaction, they use a series of pre-built prompt templates. These templates are designed to systematically extract and process information from the set of documents 114 in a highly structured and efficient manner. The pre-built prompts guide the interaction with the logic-trained LLM 110, ensuring that the queries and commands are precisely aligned with the goal of deriving the domain logic model 118. The logic-trained LLM 110, with its enhanced capabilities in understanding and applying logical constructs, interprets and analyzes the contents of the documents 114 under the framework provided by these templates. This process results in the transformation of the information in the documents 114 into a logic specification format, which essentially means converting the data into a structured, formal logic representation. This representation is what constitutes the domain logic model 118. By using pre-built prompt templates, the domain expert 112 can effectively harness the advanced capabilities of the logic-trained LLM 110, ensuring that the derived domain logic model 118 is both accurate and highly tailored to the specific requirements of the domain as represented in the documents 114.

The output from the DMC 116 is the formal domain logic model 118 expressed in formal logic for use with automated solver. The formal logic expression allows the domain logic model 118 to be utilized with an automated solver. An automated solver refers to a system or tool capable of processing logical expressions and solving logical problems or queries. By expressing the domain logic model in formal logic, the DMC 116 ensures that this model can be seamlessly integrated with such solvers. This integration is useful because it enables the automated application of the domain logic model 118 in various operations, such as verifying the accuracy of responses generated by other systems like the vanilla LLM 102. The formal logic format provides a structured, rule-based framework that can be systematically interpreted and manipulated by the solver.

In some embodiments, the DMC 116 is equipped with the capability to generate the domain logic model 118 in a fully automated manner, independent of direct guidance or input from the domain expert 112. In these scenarios, the DMC 116 relies on its advanced algorithms and possibly pre-programmed criteria to process and interpret the set of documents 114 on its own. It extracts pertinent information, converts it into a structured logic format, and constructs the domain logic model 118 without the need for step-by-step oversight or instructions from the domain expert 112. This automated process of domain logic model 118 creation enhances efficiency, as it reduces the reliance on human intervention and accelerates the domain logic model 118 development cycle.

Even in scenarios where the DMC 116 demonstrates the capability to autonomously generate a complete and accurate domain logic model 118 from the set of documents 114, there may still be instances where intervention or verification by the domain expert 112 is necessary. This need arises particularly in cases where the source documents 114 themselves present ambiguities or inconsistencies. While the DMC 116 is equipped with sophisticated algorithms to process and translate document content into the domain logic model 118, its ability to resolve inherent ambiguities or contradictions in the source documents 114 is inherently limited. In such situations, the nuanced understanding and interpretative skills of a human expert can be used. The domain expert 112 can review the domain logic model 118 to identify and rectify any issues that stem from unclear or conflicting information in the documents 114. This human oversight ensures that the final domain logic model 118 accurately reflects the intended meanings and stipulations of the source material, maintaining the integrity and reliability of the domain logic model 118. Thus, while the DMC 116 offers significant automation and efficiency in domain logic model 118 creation, the expertise and judgment of the domain expert 112 may be needed to ensure the highest quality and accuracy of the final domain logic model 118, especially in complex or nuanced domains.

The domain logic model 118 is evaluated to ensure its completeness and consistency. This evaluation is carried out using a trusted solver 122 which could be, for example, a Satisfiability Modulo Theories (SMT) solver. A function of the trusted solver 122 is to generate various scenarios that are either allowed or disallowed by the rules and stipulations defined in the domain logic model 118. These scenarios serve as test cases or examples that reflect the logical outcomes derived from the domain logic model 118's parameters. The domain expert 112 then examines these scenarios to assess their correctness and alignment with the intended logic and knowledge of the domain. This process is useful for verifying that the domain logic model 118 not only adheres to the formal logical structures but also accurately represents the real-world rules and conditions of the domain it is intended to simulate. By analyzing the scenarios generated by the trusted solver 122, the domain expert 112 can identify any inconsistencies, gaps, or errors in the domain logic model 118. This scrutiny helps in refining the domain logic model 118, ensuring that it is both logically sound and practically relevant. The use of an SMT solver or similar tools in this process adds a layer of rigorous, systematic testing that might be challenging to achieve through manual review alone, thereby enhancing the overall robustness and reliability of the domain logic model 118.

The evaluation process described, involving the use of the trusted solver 122 to test the domain logic model 118, offers a benefit in terms of identifying inconsistencies and ambiguities within the informal documents 114 used to construct the domain logic model 118. When the domain logic model 118 is subjected to this form of rigorous analysis, the scenarios generated by the trusted solver 122 can reveal discrepancies and unclear elements that may not have been apparent during the domain logic model 118's initial construction. These inconsistencies might stem from the informal nature of the source documents 114, which could contain imprecise language, contradictory information, or incomplete details. By applying the structured, logical framework of the domain logic model 118 in a practical, scenario-based test, these issues are brought to light. This process allows for a more thorough understanding of the limitations and potential areas of improvement in the source documents 114. As a result, it not only enhances the accuracy and reliability of the domain logic model 118 itself but also provides valuable insights into the quality and clarity of the underlying documents 114. This feedback loop is useful for refining both the domain logic model 118 and the source material 114, ensuring that the final product is robust and truly representative of the domain it aims to encapsulate.

The DMC 116 can be used beyond its role in the LLM verified system 100, functioning as a stand-alone system to assist a customer 120 in various industries. Businesses and organizations often grapple with the challenge of translating their complex, domain-specific logic—such as, for example, authentication and authorization policies, intricate tax rules, network readability parameters, or railroad design guidelines—into structured, formal models that can be utilized for various purposes, including verification and decision-making. The DMC 116 can play a useful role in this transformation process. By leveraging its advanced capabilities to process and understand complex sets of information, the DMC 116 can systematically convert the often informal, nuanced business logic into a formal domain logic model 118. This domain logic model 118, structured in a logical and systematic format, becomes a valuable tool for businesses. It can be used to verify the consistency and applicability of their operational policies and rules, ensuring that they align with the intended objectives and comply with relevant standards and regulations. Additionally, such a domain logic model 118 can facilitate automated decision-making processes, enhance regulatory compliance, and provide a framework for simulating and testing various scenarios.

The multi-tenant provider network 104 encompasses a sophisticated network infrastructure designed to serve multiple tenants or clients simultaneously, while ensuring the segregation and security of each tenant's data and operations. In multi-tenant provider network 104, a variety of services and resources are provided, which can be shared among different tenants, yet with strict policies and mechanisms in place to maintain privacy and prevent any cross-tenant interference. The multi-tenant provider network 104 may include a range of systems and components, such as domain model creators, answer verification systems, and logical models, all integral to providing a comprehensive suite of services. The multi-tenancy aspect is particularly useful in environments where scalability, resource optimization, and cost-effectiveness are key concerns, such as cloud computing platforms or large-scale data processing centers. Each tenant within multi-tenant provider network 104 can access and utilize the shared resources and services according to their specific needs, while the underlying infrastructure ensures that their operations remain isolated and secure from other tenants. This setup allows for efficient resource utilization, flexibility, and the ability to scale services up or down as per the demand of each tenant, making it a useful solution for businesses and organizations that require robust, scalable, and secure IT infrastructure.

A customer data network 122, within the framework of the LLM verifier system 100, represents a dedicated segment of the overall architecture specifically tailored to the end users, or customers of the multi-tenant provider network 104. The customer data network 122 primarily focuses on the interaction between the customers and the large language model services. Key components typically include the customer 120's own systems and possibly the vanilla LLM 102, although the vanilla LLM 102 can be external to customer data network 122. The customer 120, which can be an individual, a business, or an organization, access the vanilla LLM 102 provided through the customer data network 122 for a variety of purposes, such as querying information, generating content, or solving specific problems. The vanilla LLM 102 here is a standard, general-purpose model that is capable of processing and responding to a wide range of queries. The customer data network 122 is designed to be user-friendly and accessible, allowing the customer 120 to easily interact with the vanilla LLM 102 without needing in-depth technical knowledge of the underlying processes.

The domain expert data network 124 is a specialized component of a larger system designed to integrate and leverage the expertise of domain experts. The domain expert data network 124 encompasses the domain expert 112, the logic-trained LLM 110, and the curated set of documents 114 containing detailed domain-specific information. The domain expert 112 is an individual or an entity with a profound understanding and experience in particular fields. The logic-trained LLM 110 is a variant of a standard LLM, but it is specifically trained and tailored to incorporate the nuances and complexities of the domain-specific knowledge. The logic-trained LLM 110 works in tandem with the domain expert 112, processing and analyzing the information contained in the set of documents 114. These documents 114 serve as the knowledge base for the domain expert data network 124, encompassing detailed, domain-specific data, rules, regulations, and other pertinent information.

The intermediate data network 126 (e.g., the Internet) serves as a connecting framework within the LLM verifier system 100, linking the multi-tenant provider network 104, the customer data network 122, and the domain expert data network 124. The intermediate data network 126 facilitates seamless communication and data exchange among these distinct yet interdependent networks. The multi-tenant provider network 104, with its array of services and resources, the customer data network 122, focusing on end-user interactions, and the domain expert data network 124, emphasizing specialized knowledge and expertise, each serve unique functions. The intermediate data network 126 ensures that these diverse components operate harmoniously, allowing for the efficient transfer of information and requests between them. For instance, it enables customer queries from the customer data network 122 to be processed and verified through the services in the multi-tenant provider network 104, and further enriched or validated by the domain-specific insights from the domain expert data network 124.

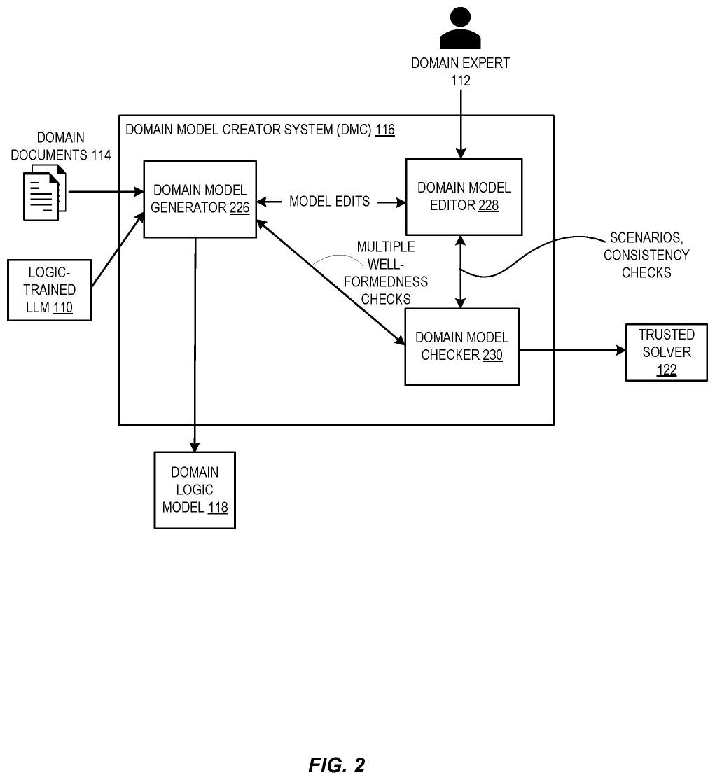

FIG. 2 illustrates subsystems and detailed operation of the domain model creator 116. The domain model generator 226 within the DMC 116 operates to construct the domain logic model 118, drawing from a comprehensive set of resources 114 for its inputs. The domain model generator 226 utilizes the set of documents 114, which contain vital and detailed information pertinent to the specific domain. These documents 114 serve as the foundational data pool from which the domain logic model 118 is constructed, providing the necessary factual and conceptual framework. In addition to this, the domain model generator 226 may also incorporate inputs from the domain expert 112, facilitated through the domain model editor 228. This input from the domain expert 112 is useful, as it brings in expert knowledge, insights, and contextual understanding that might not be fully captured in the documents 114 alone. The domain expert 112 can provide clarifications, highlight key aspects, or suggest modifications that ensure the domain logic model 118 aligns accurately with the real-world intricacies and nuances of the domain. By integrating these two primary sources of information—the detailed data from the documents 114 and the expert insights from the domain expert 112—the domain model generator 226 effectively constructs the domain logic model 118. The domain logic model 118 serves as a structured, logical representation of the domain's knowledge, useful for various applications such as verifying responses from the vanilla LLM 102 or aiding in decision-making processes within that domain.

The domain model generator 226 operates as an asynchronous process, particularly during the initial phase of generating the domain logic model 118. This asynchronous approach means that the process of the domain logic model 118 generation is not bound to a linear, step-by-step sequence of operations; instead, it runs independently in the background, allowing for other processes to occur simultaneously without interruption. This approach is especially efficient for handling complex and time-consuming tasks like analyzing large sets of documents 114 and constructing detailed domain logic models 118, as it doesn't tie up the DMC 116's system resources.

Once the domain logic model 118 is initially generated by the domain model generator 226, it is then exported to the domain model editor 228. This transition marks the shift from automated model generation to a more interactive phase of domain logic model 118 development. In the domain model editor 228, the domain logic model 118 becomes accessible for review, editing, and refinement by the domain expert 112. This stage is useful for incorporating expert knowledge and insights, as the domain expert 112 can make adjustments, add nuances, or correct potential inaccuracies in the domain logic model 118. The ability to edit and refine the domain logic model 118 ensures that it accurately reflects the complexities and specificities of the domain, enhancing its reliability and applicability. This workflow, from asynchronous generation to expert-led refinement, exemplifies a comprehensive approach to creating highly accurate and specialized domain logic models 118.

The domain model checker 230 plays a useful role in the ecosystem of the DMC 116, functioning as a support system for both the domain model generator 226 and the domain model editor 228. A function of the domain model checker 230 is to perform automated reasoning on the domain logic model 118 with the aid of trusted solver 122. This involves an in-depth analysis to ascertain whether the domain logic model 118 is complete and consistent. Completeness refers to the domain logic model 118's ability to encompass all necessary elements and aspects of the domain it represents, while consistency ensures that there are no internal contradictions or logical fallacies within the domain logic model 118. The domain model checker 230 applies sophisticated algorithms to scrutinize the domain logic model 118 against these criteria, effectively validating its structural and logical integrity. Once this analysis is complete, the domain model checker 230 plays another useful role: it reflects “scenarios” back to the domain expert 112. These scenarios are essentially practical applications or simulations derived from the domain logic model 118, showcasing how the domain logic model 118 would behave or respond in various situations. This feedback is invaluable for the domain expert 112, as it provides a tangible representation of the domain logic model 118's functionality and allows the expert to visualize its real-world implications. By presenting these scenarios, the domain model checker 230 aids the domain expert 112 in identifying any potential gaps, inaccuracies, or areas for enhancement in the domain logic model 118. This collaborative process between the automated reasoning of the domain model checker 230 and the expert oversight of the domain model editor 228 ensures that the final domain logic model 118 is not only technically sound but also practically relevant and robust.

Once the domain logic model 118 is finalized, the LLM verifier system 100 progresses to a subsequent stage which involves providing guardrails for the answers generated by the vanilla LLM 102. This stage is useful for ensuring that the responses from the vanilla LLM 102 are not only accurate but also align with the specific constraints and guidelines established by the domain logic model 118. The finalized domain logic model 118 acts as a benchmark or a framework of reference, encapsulating the domain's specific knowledge, rules, and logical structures. In this stage, the vanilla LLM 102's responses are cross-checked against this domain logic model 118. The guardrails function as a filtering and guiding mechanism, ensuring that the vanilla LLM 102's outputs adhere to the domain's standards and do not deviate into areas of inaccuracy or irrelevance. This process is useful, particularly in scenarios where precision and domain-specific accuracy are paramount. It helps mitigate the risk of erroneous or contextually inappropriate responses that might arise due to the general-purpose nature of the vanilla LLM 102. By integrating the domain logic model 118's guardrails with the vanilla LLM 102, the LLM verifier system 100 effectively harnesses the vanilla LLM 102's powerful generative capabilities while maintaining a high degree of domain-specific reliability and relevance. This integration enhances the overall utility and trustworthiness of the vanilla LLM 102's responses, making it a more valuable tool for customers requiring domain-specific information or guidance.

Initially, in the operational workflow of the LLM verifier system 100, the customer 120 engages directly with the vanilla LLM 102. This interaction is the starting point of the process, where the customer 120, who can be either a human user or an automated system, submits queries or requests to the vanilla LLM 102. The vanilla LLM 102, being a general-purpose language model, is designed to understand and process a wide range of natural language inputs, making it versatile and accessible for diverse users. In the case of a human customer 120, this interaction might involve typing out a question or command, while an automated system might send a structured query. The vanilla LLM 102 then processes these inputs, applying its extensive language understanding and generation capabilities to formulate appropriate responses or actions. This initial interaction is useful as it sets the context and provides the input data based on which subsequent processes in the LLM verifier system 100 are triggered. The vanilla LLM 102 serves as the primary interface for the customer 120, providing an intuitive and flexible means for them to access the LLM verifier system 100's capabilities and initiate tasks or seek information.

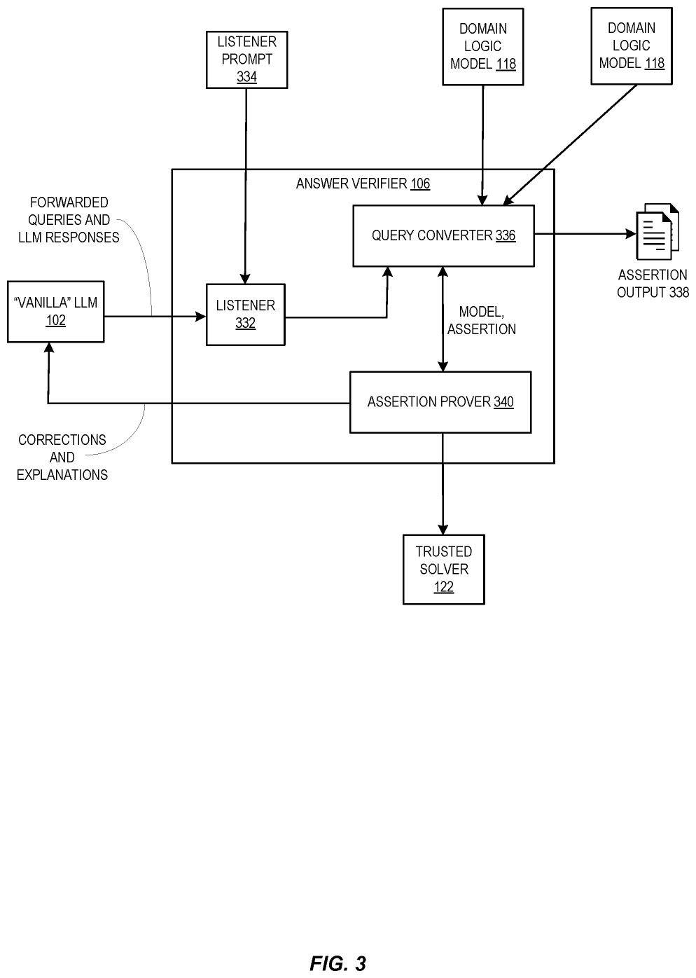

Referring now to FIG. 3, which illustrates subsystems and detailed operation of the answer verifier, when the vanilla LLM 102 generates a response to a query posed by the customer 120, an evaluation process is initiated by a listener component 232 within the answer verifier system 106. This listener component 332 is tasked with examining the context of the interaction between the customer 120 and the vanilla LLM 102. Its objective is to ascertain whether the query and the resulting answer fall within the purview of the domain logic model 118.

There are various ways to ascertain whether the query and the answer fall within the domain of the domain logic model 118. In one way, the listener component utilizes a specific listener prompt 334 provided by the DMC 116. This prompt is designed to guide the listener component 332 in identifying the key aspects of the query and response that are pertinent to the domain logic model 118. It acts as a filter or a lens through which the listener component 332 views the vanilla LLM 102's interaction, helping it to discern whether the subject matter aligns with the specialized knowledge and rules encapsulated in the domain logic model 118. If the query is determined to be relevant to the domain logic model 118, the answer verifier system 106 can then proceed to apply the domain logic model 118 for further verification or refinement of the vanilla LLM 102's response. This process ensures that the answers provided by the vanilla LLM 102 are not only contextually appropriate but also adhere to the specific standards and accuracy required by the domain in question.

Another way to ascertain whether the query and answer fall within the purview of the domain logic model 118 is to use semantic embeddings. A semantic embedding representing the query and answer can be compared to one or more semantic embeddings representing the domain logic model 118 or the documents 114 from which the domain logic model 118 is derived. These embeddings are numerical representations that capture semantic meaning. By converting the query and answer into their semantic embedding forms, they can be quantitatively compared to the embeddings representing the domain logic model 118. This comparison assesses how closely the query and answer relate to the underlying logic and information encapsulated in the model. Additionally, or alternatively, since the domain logic model 118 is derived from specific documents (referred to as documents 114), the embeddings of the query and answer can also be compared against embeddings of these source documents. A comparison can be for distance (e.g., cosine distance) between embeddings in an embedding space. If the distance is below a threshold indicating a greater semantic similarity, then the query and answer is considered within the purview of the domain logic model 118. On the other hand, if the distance is greater than the threshold indicating a lesser semantic similarity, then the query and answer is considered outside the purview of the domain logic model 118.

If the listener component 332 within the answer verifier system 106 determines that a query posed to the vanilla LLM 102 by the 120 is relevant to the domain logic model 118, the process then advances to the next stage. In this stage, the context of the query is routed to a query converter 336, which is also a part of the answer verifier 106. The role of the query converter 336 is to transform the informal query, along with the answer provided by the vanilla LLM 102, into a formal assertion 338 in logic. This transformation is a useful step in aligning the informal, natural language format of the query and response into a structured logical framework. Converting the query and the vanilla LLM 102's answer into a logical assertion 338 involves translating the nuances of natural language into a precise, formal logic syntax, which is more suited for rigorous analysis and verification. This logical assertion 338 encapsulates the essence of the query and the response in a format that can be systematically evaluated against the rules and principles defined in the domain logic model 118. By doing so, the system can more accurately assess the correctness and relevance of the vanilla LLM 102's response in the context of the domain-specific knowledge and guidelines. This conversion to a formal logic assertion 338 is useful for ensuring that the responses provided by the vanilla LLM 102 not only appear contextually appropriate but also adhere strictly to the logical and factual standards required by the specific domain.

Once the query converter 336 converts the informal query and the vanilla LLM 102's answer into a formal logic assertion 338, the query converter 336 has options regarding how to utilize this output. One primary path is to send this output to the assertion prover 340, which is another part of the answer verifier 106. The assertion prover 340 then uses this logic assertion for further analysis or verification processes, aligning with the overall objective of ensuring the accuracy and relevance of the vanilla LLM 102's responses.

Additionally, or alternatively, the query converter 336 can emit its output 338 for storage purposes or for use in other systems. This flexibility allows the converted logical assertions 338 to be archived, creating a repository of previously processed queries and responses that can be referenced or analyzed later. Additionally, by making the output 338 available to other systems, the query converter 336 enables the integration of its processed data into different parts of the larger network or even external systems. This can facilitate a range of applications, from deeper data analysis, machine learning training, to cross-systems collaborations, enhancing the overall utility and reach of the data processed by the query converter 336. This multi-faceted approach to handling the output 338 underscores the query converter 336's role not just as a translator of natural language to logic assertions 338, but also as a crucial node in the broader data processing and distribution network within the LLM verifier system 100.

The assertion prover 340 of the answer verifier system 106 employs a trusted solver 122 to assess the validity of the assertions 338 generated by the query converter 336. The assertion prover 340 determines whether each assertion 338—representing a query and its corresponding response from the vanilla LLM 102—is valid, invalid, or neither valid, not invalid. In this context, ‘valid’ means that a first query of the trusted solver 122 in terms of the domain logic model 118 and the assertion 338 is unsatisfiable. “Invalid” means that a second query of the trusted solver 122 in terms of the domain logic model 118 and the assertion 338 is unsatisfiable. If both the first query and the second query are satisfiable, then the assertion 338 is neither valid nor invalid. The assertion prover 340 in cooperation with the trusted solver 122 rigorously tests each assertion 388 to arrive at this valid, invalid, or neither valid not invalid verdict.

In certain embodiments of the system, the DMC 116 and the answer verifier 106 evolve and operate independently, each providing distinct value in its own right without reliance on the other. The DMC 116, focused on creating detailed domain logic models 118, is a powerful tool for synthesizing complex domain-specific knowledge into structured, logical frameworks. This capability allows it to serve various purposes, such as aiding in decision-making, providing insights for specialized applications, or enhancing domain-specific data processing. Its utility is not confined to just verifying answers from a language model but extends to any scenario requiring a deep, structured understanding of a specific domain. On the other hand, the answer verifier 106, designed to assess and ensure the accuracy of responses from a language model like the vanilla LLM 102, can function effectively as a standalone system for quality control in language processing. It can independently verify the relevance and correctness of answers generated by a LLM, making it valuable in applications where precision and reliability of language model outputs are critical. The independent evolution of these systems means that while they can complement each other when integrated, they are not inherently dependent on one another. Each system can be applied in various contexts, leveraging their unique capabilities to enhance the understanding, processing, and utilization of domain-specific knowledge and language model responses respectively.

The domain logic model-creation ability of the DMC 116 significantly simplifies and democratizes the process of modeling various domains, making it a valuable asset in a wide range of applications, including those where Large Language Models (LLMs) are not involved. Traditionally, creating accurate and reliable domain models required extensive expertise and resources, making it a challenging and resource-intensive task. However, with the DMC 116's advanced capabilities, this process becomes more accessible and efficient. The DMC 116 automates and streamlines the construction of domain logical models 118, translating complex, domain-specific knowledge and data into structured, logical models with relative ease. This lowers the barrier to entry for organizations and individuals looking to develop models for their specific domains, whether it be in healthcare, law, finance, or any other field.

The resultant domain logic models 118 are not only useful in the context of verifying responses from LLMs but also hold independent value in other applications, particularly when used in conjunction with the trusted solver 122. For instance, these domain logic models 118 can be employed in decision support systems, automated reasoning tasks, or in any scenario where accurate domain-specific logic and knowledge are useful. The trusted solver 122 can leverage these domain logic models 118 to analyze scenarios, make predictions, or solve complex problems within the domain, providing valuable insights and solutions. The versatility and accessibility of the DMC 116 thus open up new possibilities for the application of advanced modeling and problem-solving techniques across a diverse array of fields, extending well beyond the realm of language model verification.

The answer verifier 106 ensures the quality and accuracy of responses generated by Large Language Models (LLMs) 102, particularly by verifying these responses against a formal domain logic model 118. This functionality holds significant value, even in scenarios where the formal domain logic model 118 is obtained through means other than the DMC 116, such as when a domain logic model 118 is constructed manually. In many instances, domain experts 112 or specialized teams might develop domain logic models 118 by hand, tailoring them meticulously to capture the intricate details and specific rules of their field. These manually constructed models embody a deep understanding of the domain, often incorporating nuances that are the result of expert knowledge and experience.

The answer verifier 106's ability to utilize these hand-crafted models for verification purposes is beneficial. It means that any organization or individual with an existing formal domain logic model 118, regardless of how it was created, can leverage the answer verifier 106 to assess the LLM 102's answers. This ensures that the responses are not only linguistically coherent but also conform to the specific logical and factual standards of the domain as defined in the domain logic model 118. Such verification is essential in domains where accuracy and adherence to specific knowledge are critical, such as in legal, medical, or technical fields. The answer verifier 106, therefore, becomes a versatile and powerful tool, capable of enhancing the reliability and trustworthiness of LLM 102 outputs in a wide range of applications, by aligning them with the precise and expertly crafted standards of domain logic models 118, whether they are generated automatically or constructed manually.

In some embodiments of the system, the SMT-LIB (Satisfiability Modulo Theories Library) language is utilized as the representation format for both the domain-specific model 118 generated by the DMC 116 and the assertions 338 produced by the query converter 336. SMT-LIB is a standard language used in the field of formal verification and logic solving, recognized for its ability to represent logical expressions and theories accurately and efficiently. SMT-LIB provides a standardized, well-understood framework for expressing the complex logical structures of domain logic models 118. When the DMC 116 generates a domain logic model 118, it encapsulates the intricate details and rules of the particular domain in the SMT-LIB format, ensuring that the domain logic model 118 is not only precise but also compatible with various logic solvers (e.g., 122) and verification tools. Similarly, when the query converter 336 transforms the informal queries and the vanilla LLM 102's answers into formal assertions 338, it does so by use of the SMT-LIB language. This ensures that these assertions 338 are in a format that can be readily processed and analyzed by the system 100's logic solver 122. The uniform use of SMT-LIB across these components facilitates seamless integration and interoperability within the system 100, allowing for efficient and accurate verification of LLM responses against the domain logic models 118.

In certain embodiments of the LLM verifier system 100, a useful feature is its agnosticism towards specific logic languages, which offers considerable flexibility in terms of the logics and notations used. This means that the system 100 is not restricted to any single logic representation format or formal specification language, such as SMT-LIB. This flexibility is particularly evident in the design of the query converter 336 and the assertion provider 340, which are pluggable components. Being pluggable means that these components can be configured or replaced to support different logics and notations, according to the needs of the specific domain or application. This adaptability is useful in contexts where specialized or non-standard logic languages are more appropriate or widely used. For instance, a domain might rely on a unique logical framework or notation that captures its nuances more effectively than the standard formats like SMT-LIB. In such cases, the system 100 can accommodate these specific requirements by plugging in a different logic module into the query converter 336 and the assertion provider 340. This ability to use various logics and notations enhances the system 100's versatility and applicability across a wide range of domains, making it a useful tool for verifying LLM responses in diverse fields with varied logical requirements. The logic language agnosticism of the system thus broadens its potential use cases and user base, ensuring its relevance and efficacy in a variety of specialized scenarios.

### Equivalence Checking for Translations From Natural Language to Formal Logic

In some embodiments of a LLM verifier system, an equivalence checking technique is implemented by the system to enhance the reliability of translations from natural language to formal logic. This technique ensures the accuracy of the process wherein the queries and responses in natural language, as generated by a LLM, are converted into formal logical assertions by the verifier system.

The verifier system is designed to handle interactions between a user and an agent (e.g., a vanilla LLM) with a mechanism for ensuring the accuracy and relevance of the agent's responses. In this setup, the system captures the context of the ongoing conversation, which is useful for understanding the nuances and specificities of the dialogue. Once the agent provides an answer to the user's query, the verifier system employs multiple Large Language Models (LLMs) to translate this last response from the agent into formal logic. This translation converts the often nuanced and contextually rich natural language response into a structured and precise logical format.

The purpose of this conversion is to facilitate the verification of the agent's answer against a specialized knowledge base composed of logical facts. This knowledge base serves as a repository of verified information and rules, structured in formal logic, allowing for rigorous comparison and validation. By querying the translated response against this knowledge base, the verifier system can determine whether the response is accurate, logically sound, and consistent with the established facts and principles in the knowledge base.

In some embodiments, the verifier system translates natural language into formal logic, such as formal logic used in verifying responses from Large Language Models (LLMs), using the standardized syntax of SMT-LIB, which is a recognized language for Satisfiability Modulo Theories (SMT). SMT-LIB provides a structured and precise way to represent various logical constructs in first-order logic, making it a useful choice for formal verification and logical reasoning tasks. However, the verifier system's design is flexible and adaptable, allowing for the use of other logics or languages according to the specific needs and requirements of the particular implementation.

In the process of translating natural language to formal logic, numerous challenges can lead to undesired or inaccurate results. Natural language often encompasses ambiguities and vagueness, which are inherent in everyday communication but problematic in logical analysis, where precision is key. Additionally, when using Large Language Models (LLMs) for translation, there is a risk of ‘hallucination,’ where the LLM generates plausible but factually incorrect or irrelevant information. To mitigate these issues, the verifier system may employ multiple LLMs to perform several translations of the same natural language input into formal logic. This multiplicity approach is grounded in the principle that different LLMs, possibly with varying architectures or training data, might interpret and translate the same text in slightly different ways. By comparing these multiple translations, the verifier system can identify and reconcile discrepancies, leading to a more robust and reliable final translation. This method effectively counters the inherent unpredictability and variability of natural language and the idiosyncrasies of individual LLMs. Utilizing multiple translations provides a broader perspective and a cross-checking mechanism, significantly enhancing the accuracy and reliability of the translation from natural language to formal logic. This approach is particularly valuable in applications where precision and correctness are critical, such as in legal, medical, or technical fields, where the stakes of misinterpretation are high.

In the process of verifying translations from natural language to formal logic, a theorem prover, such as a Satisfiability Modulo Theories (SMT) solver, may be used. This tool is employed to conduct equivalence checks among the various translations generated by the multiple Large Language Models (LLMs). The SMT solver examines these different logical translations for consistency and equivalence, essentially testing whether they represent the same meaning or information despite potential variations in their expression. Based on the level of agreement or consistency observed among the translations provided by the LLMs, the verifier system then follows one of two paths. If there is a significant level of agreement among the translations, the verifier system identifies a ‘desired’ translation—one that is deemed most accurate and representative of the original natural language input. This translation is then used for further processing or verification tasks. On the other hand, if the translations vary widely, indicating a lack of consensus, it suggests that the original natural language input is too ambiguous or complex to be reliably translated into formal logic. In such cases, the verifier system flags the input as potentially problematic, indicating that a high-quality, reliable translation cannot be guaranteed.

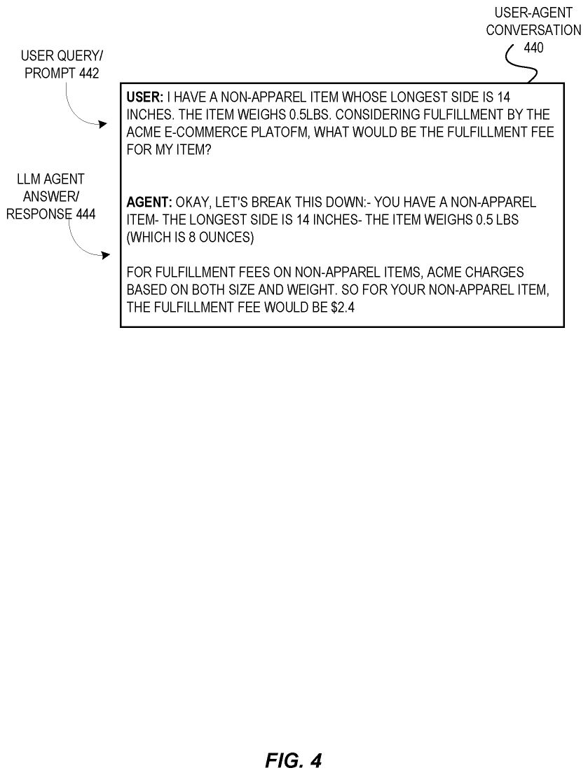

FIG. 4 provides an example conversation between a user and an LLM agent. The LLM agent can be a vanilla or general-purpose LLM, for example. The conversation 440 encompasses a query or prompt 442 by the user which asks about the fulfillment fee charged by the Acme e-commerce platform for a non-apparel item with certain specified characteristics. The conversation 440 also encompasses an answer 444 generated by the LLM in response to the prompt 442.

According to some embodiments, an LLM verifier system determines if the answer 444 is correct. The LLM verifier system operates as an intermediary in conversations between a user and an LLM (Large Language Model) agent. Its primary function is to analyze and process the dialogue exchanges within these interactions. The system specifically focuses on instances where a user poses a query, and the LLM agent provides a response. Upon receiving such a conversation, the LLM verifier system actively engages in refining the dialogue to create a more focused prompt. This refined prompt is uniquely designed to distill the essence of the conversation by extracting the main answer provided by the LLM agent and to translate this main answer into first-order logic, a formal representation that structures the answer in a logically rigorous format. The LLM verifier system submits the refined prompt to multiple other LLMs. By querying different language models, it gathers a variety of translations, each offering a unique perspective or interpretation in first-order logic.

For example, supports conversation 440 is submitted by the LLM verifier system to three other LLMs and the following three translations to first-order logic are received from the three other LLMs:
Translation A1: ¬isApparel(item)∧weightInLbs(item)=0.5∧longestSide(item)=14∧fee(item)=2.41
Translation A2: ¬isApparel(item)∧longestSide(item)=14∧weightInLbs(item)=0.5 ∧fee(item)=2.41
Translation A3: isApparel(item)∧weightInLbs(item)=0.5∧longestSide(item)=14∧fee(item)=2.41

In the above translations, the ‘¬’ character stands for logic not, and ‘∧’ stands for logical and. Translation A1 and Translation A2 are reasonable translations, even though they are syntactically different (e.g., the order in which they state facts differs). Translation A1 and Translation A2 state the same facts and are logically equivalent. Translation A3, however, does not negate the atom isApparel (item). Thus, Translation 3 falsely claims that the item is apparel as opposed to non-apparel as stated in the conversation 440.

In some embodiments, the LLM verifier system uses a theorem prover (e.g., an Satisfiability Modulo Theories (SMT) solver) to perform equivalence checks among all the translations. This component is specifically employed to conduct equivalence checks among the various translations obtained from the different LLMs. After the main answer from the conversation 440 is extracted and translated into first-order logic by the multiple LLMs, these translations, though structurally different, are intended to convey the same logical content. The theorem prover is used by the LLM verifier system to verify the logical equivalence of these translations.

Based on the equivalence checks performed by the LLM verifier system, the set of first-order logic translations are partitioned into sets of logically equivalent translations. For example, Translation A1 and Translation A2 are in one set of logically equivalent translations and Translation A3 in its own separate set of logically equivalent translations. The LLM verifier system then decides on a desired translation based on the level of agreement between the translations. For example, the LLM verifier system may decide that either Translation A1 or Translation A2 is a desired translation based on Translation A1 and Translation A2 being in the largest logically equivalent set or in the set with greatest cardinality. Alternatively, the LLM verifier system may decide to be stricter and require unanimous agreement. In this case, since Translation A1, Translation A2, and Translation A3 are not logically equivalent, then LLM verifier system may determine that there is no desired translation among the three.

In the above example, the LLM verifier system checks for logical equivalence among the three translations while ignoring additional context. In some embodiments, the LLM verifier system determines logical equivalence with respect to a given knowledge base that encompasses a set of logical formulas. By doing so, more equivalences are captured. For example, consider the following two first-order logic translations of the sentence: “The weight of the item is 0.5 pounds (eight ounces).”:
Translation B1: weightInLbs(item)=0.5
Translation B2: weightInOz(item)=8

A strict logical equivalence check by the LLM verifier system using a theorem prover without additional context may return a result that the two translations are not logically equivalent, when, in fact, they are in context. Accordingly, in some embodiments, the LLM verifier system checks equivalence of translation with respect to a knowledge base based on logical formulas. For example, assuming a knowledge base contains the statement which represents that the weight of an item in ounces is eight times its weight in pounds:
Statement B1: ∀x weightInOz(x)=weightInLbs(x)×8

By checking equivalence against this knowledge base, the LLM verifier system can identify the two translations, Translation B1 and Translation B2, are equivalent. Upon determining so, the LLM verifier system can pick one of the translations as the desired translation.

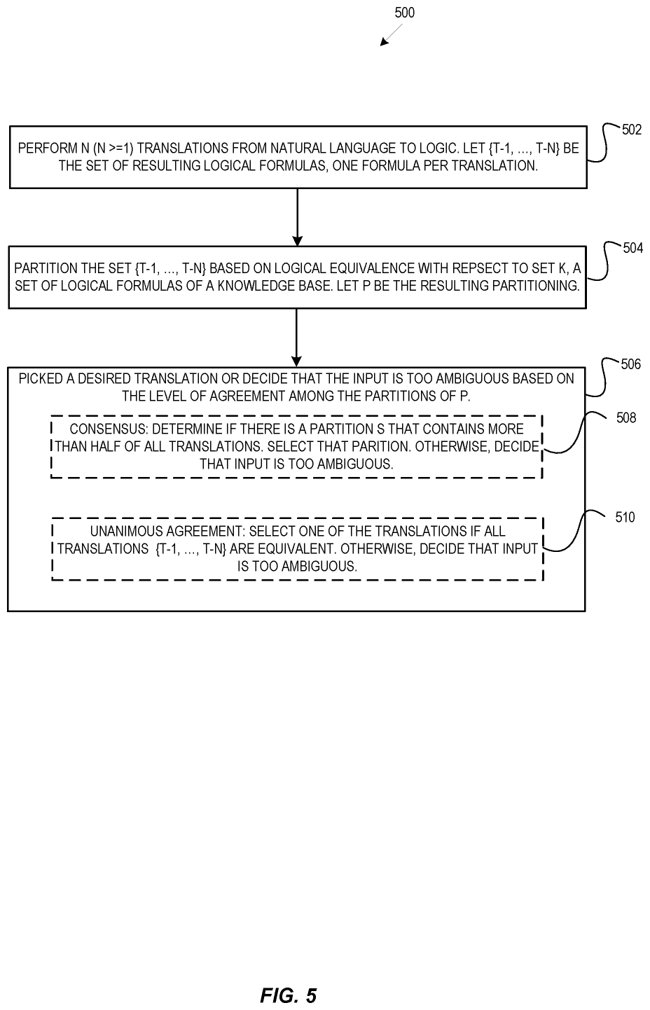

FIG. 5 is a flowchart 500 of a method for selecting a desired translation of natural language to logic. The method may be performed by a LLM verifier system. For example, the method may be performed by the answer verifier system 106 of the LLM verifier system 100 of FIG. 1 to translate a conversation between the customer 120 and the vanilla LLM 102 to a logic statement where the logical validity of the statement within a domain is checked with respect to the domain logic model 118 using the trusted solver 122 as described above.

At block 502, the LLM verifier system performs two or more translations of the conversation (e.g., using a refined prompt as described above) to respective logic statements. Let {T-1, . . . , T-N} be the set of resulting logical formulas with one formula per translation. The translations can be obtained from different LLMs or each from one or more LLMs multiple times.

Let K be a set of logical formulas of a knowledge base. At block 504, the set {T-1, . . . , T-N} is partitioned based on logical equivalence with respect to K. Two logical formulas T-i and T-j in the set {T-1, . . . , T-N} may be considered logically equivalent with respect to the set K if K|=T-i↔T-j, where |= stands for logical entailment and ↔ stands for logical equivalence. For this purpose, it may be assumed that logic precisely defines the concepts of entailment and equivalence. For example, the logic can be first-order logic. In the case of first-order logic, the LLM verifier system can perform the equivalence check using a theorem prover such as, for example, a first-order theorem prover or an SMT solver to determine whether the formula K∧¬(T-i↔T-j) is unsatisfiable. If so, then T-i and T-j are equivalent with respect to K, otherwise they are not equivalent. Let P be the resulting partitioning. In particular, P is a set having non-overlapping subsets of {T-1, . . . , T-N} as elements where, for each such subset S, all elements within S are equivalent with respect to K.

At block 506, a desired translation is picked, or a decision is made that the input is too ambiguous. This determination is based on the level of agreement among the partitions in P. Two example strategies are provided. At block 508, if there is a partition S in P that contains more than half of all translations (e.g., |S|>N/2), then selecting a translation from S as the desired translation. Otherwise, it is decided that the input is too ambiguous. At block 510, as an alternative, if all translations {T-1, . . . , T-N} are equivalent with respect to K, one of the translations is selected as the desired translation. Otherwise, it is decided that the input is too ambiguous.

It should be noted that it is possible to check weaker relations than equivalence for translation using theorem provers (e.g., SMT solvers). An example of a weaker relation is an implication. For example, with implications, the LLM verifier system could determine whether one LLM specified a “stronger” property than another. For example, consider the following two translations of the conversation 440 of FIG. 4:
Translation C1: ¬isApparel(item)∧weightInLbs(item)=0.5∧longestSide(item)=14∧fee(item)=2.41
Translation C2: ¬isApparel(item)∧weightInLbs(item)=0.5∧fee(item)=2.41

In the example translations above, Translation C1 implies Translation C2, as it is harder to satisfy. Weaker relations than equivalence can be considered if some LLMs tend to miss “picking up” parts of the formula in the text. In this case, the LLM verifier system can choose the antecedent formula, Translation C1, as the desired translation as it is more complete. While using weaker relations rather than equivalence results in less confidence in the desired translation, it may still nonetheless be appropriate according to the requirements of the particular implementation at hand.

### Exhaustive Model Enumeration for Scenario Generation

As discussed above, the LLM verifier system 100 can be used to translate natural-language texts into a knowledge base in the form of a domain logic model 118. To perform the translation from natural language, the LLM verifier system 100 uses LLMs. To provide the domain expert 112 with increased confidence that the logical formulizations of the domain logic model 118 matches the meaning of the original natural language text (e.g., documents 114), the trusted solver 122 is used to generate various scenarios that are either allowed or disallowed by the rules and stipulations defined in the domain logic model 118. A “scenario” in this context may be defined as a list of facts that are consistent with (e.g., allowed by) the domain logic model 118. By examining a scenario, the domain expert 112 can decide whether the scenario should indeed be allowed or not. If not, the domain expert 112 can interact with the LLM verifier system 110 to modify the domain logic model 118.

As an example, scenario for a zoning law, assume the zoning law defines how many accessory dwelling units (ADUs) are allowed on a site. Assume the zoning law has the following three rules:
Rule D1: If the site is in zone RF, and if the dwelling type on the site is a house or manufactured home, there can be at most one ADU.
Rule D2: If the site is in zone RF, and if the dwelling type on the site is a duplex, there can be no ADUs.
Rule D3: If the site is in a zone that is different from RF, there can be at most two ADUs.

After translating these three rules to logic, the following three first-order formal logic statements may be obtained:
Statement D1: (zone(site)=RF∧dwellingType(site)=Duplex)→maxADUs(site)=0
Statement D2: (zone(site)=RF∧(dwellingType(site)=House∨dwellingType (site)=ManufacturedHome))→maxADUs(site)=1
Statement D3: zone(site)=RF→maxADUs(site)=2

In the above statements, the ‘∨’ symbol means logical or. The LLM verifier system 100 provides the domain expert 112 a way to test whether the logical formulas really capture the meaning of the three zoning rules. To do this, the LLM verifier system 100 generates models of the logic formulas, translates the models to natural language, and presents the natural language translations to the domain expert 112. These models are referred to as “scenarios” in the context of the LLM verifier system 100. The scenarios in the translated natural language form are presented to the domain expert 112 (e.g., in a GUI) and the domain expert 112 is prompted to confirm that the scenarios match their intent. If a scenario does not match the intent of the domain expert 112, then the domain expert 112 may interface with LLM verifier system 100 (e.g., via a text editor or other suitable graphical user interface) to modify the logical formulas accordingly to fix any problems.

For example, for the above logical formulas, the following three scenarios may be generated by the LLM verifier system 100:
Scenario D1: The zone of the site is RF. The dwelling type on the site is a duplex. The maximum number of allowed accessory dwelling units is 0.
Scenario D2: The zone of the site is RF. The dwelling type on the site is not a duplex. The maximum number of accessory dwelling units allowed is 1.
Scenario D3: The zone of the site is not RF. The maximum number of allowed accessory dwelling units is 2.

These scenarios capture the meaning of the original zoning rules. If they did not do so, such as, for example, if Scenario D2 was generated as “The zone of the site is not RF. The maximum number of allowed accessory dwelling units is unrestricted,” then the domain expert 112 can modify (edit) Scenario D3 accordingly.

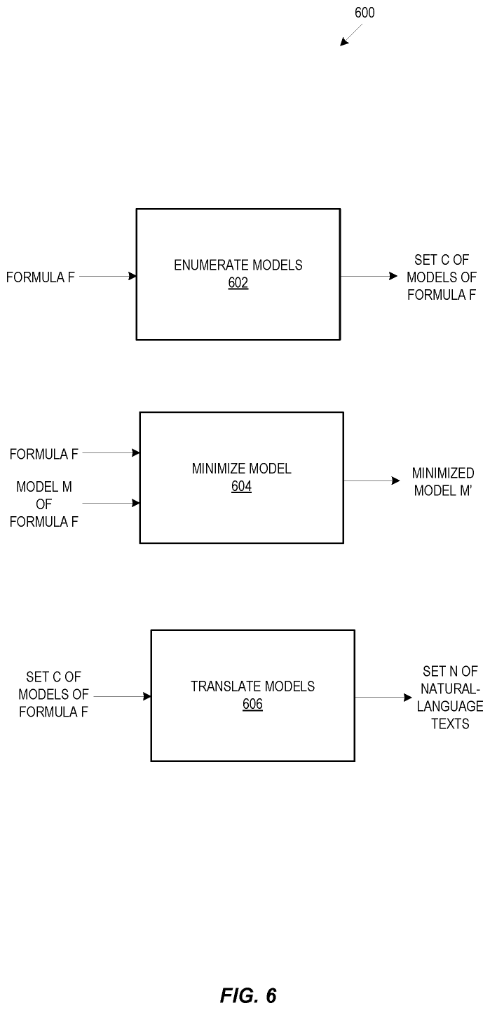

FIG. 6 depicts three different procedures implemented by the LLM verifier system 100 (e.g., the domain model creator system 116) that together produce a set of scenarios as described above. The main input is a formula F of first-order logic without quantifiers that represent the logical formulization of a natural-language text. For example, formula F may be specified in a SMT-LIB syntax.

The exclusion of quantifiers in the formula F simplifies the logical representation by focusing on basic propositional elements and their relationships, rather than on the more complex expressions of generality or quantity often found in natural language. In some embodiments, however, quantifiers are permitted if the logical formulas adhere to restrictions enabling a finite universe such as, for example, by restricting to ground atoms of the Herbrand universe within certain syntactic restrictions. The Herbrand universe is a concept in logic that encompasses all possible constants and ground terms that can be constructed from the signature of a given theory (e.g., its function symbols and constants). Ground atoms refer to the atomic formulas or propositions in this universe, which are constructed without the use of variables. By limiting the quantifiers to these ground atoms with certain syntactic restrictions, the system effectively constrains the range of quantification to a finite and more manageable set of elements. This restriction simplifies the interpretation and manipulation of quantified formulas, as it avoids the complexity associated with unrestricted quantification over potentially infinite domains. It also allows the system to retain the precision and specificity of first-order logic while incorporating the expressive power of quantifiers. This approach is useful in computational logic and automated reasoning systems, where handling quantifiers efficiently and effectively is essential for accurately processing and understanding the logical implications of natural-language texts.

As depicted, the Enumerate Models procedure 602 takes a formula F as input and returns an exhaustive set C of models that satisfy this formula F. When a formula F, which is a specific statement or a set of statements in logic, is input into this procedure 602, it initiates a systematic exploration of all possible interpretations or configurations that can make the formula true. These interpretations or configurations are known as models. Each model represents a unique way in which the variables and relations within formula F can be assigned or structured so that the formula holds true under that specific interpretation. The Enumerate Models procedure 602 uses an exhaustive approach. It does not stop at finding a single model or a subset of models that satisfy formula F. Instead, it endeavors to identify and return every possible model, creating a complete set C of all models. This exhaustive set C is useful for comprehensive analysis.

In the context of the set C produced by the Enumerate Models procedure 602, each model M within this set is uniquely represented by a set of ground literals. Ground literals are the fundamental components of these models and are characterized by their simplicity and specificity: they are atomic formulas or their negations in which no variables appear, meaning each literal is fully instantiated with specific, constant values. This representation is useful as it provides a concrete and unambiguous depiction of the model. Each ground literal in a model M effectively states a specific fact or its negation, reflecting a particular state of affairs or truth in the model's interpretation of the logical formula F. By using ground literals, the complexity that often accompanies variables and quantifiers is eliminated, leading to a more straightforward and clear understanding of what each model represents. In practice, this means that each model M in the set C can be viewed as a distinct combination of these ground literals, collectively representing one of the many ways in which the formula F can be satisfied.

The Minimize Models procedure 604 is designed to streamline and simplify models of a given logical formula. When it receives a formula F and one of its corresponding models M, the procedure's objective is to produce a minimized version of this model, denoted as M′. The model M is a specific interpretation or configuration that makes the formula F true, typically represented by a set of ground literals. The minimization process involves systematically reducing this set of literals in M to its essential core, stripping away any superfluous or non-essential elements while still maintaining the truth of formula F.

This minimization is useful because it focuses on identifying the bare minimum conditions under which the formula remains valid. By doing so, the procedure yields M′, a more concise and efficient representation of the original model. The minimized model M′ retains only those literals that are necessary for the satisfaction of formula F. The Minimize Models procedure 604 can be called (invoked) by the Enumerate Models procedure 602 to reduce the size and the number of returned models in the set C.

Procedure Translate Models 606 takes a set C of models and translates them to natural language which is the set of scenarios. The Translate Models procedure 606 bridges the gap between formal logic models and natural language understanding. This procedure 606 takes a set C of models, which are derived from a logical formula F and are represented in a formal logical language, typically as sets of ground literals. The function of Translate Models 606 is to convert these abstract, logical representations into natural language descriptions. Each model M in set C encapsulates a specific interpretation or a way in which the original logical formula F can be true, and translating these into natural language involves articulating these interpretations in a way that is comprehensible and meaningful to human users.

The outcome of this translation process is a set of scenarios, where each scenario corresponds to a model M from set C, now expressed in easily understandable language. This translation is useful as it transforms the often complex and esoteric logical models into accessible and practical narratives or descriptions.

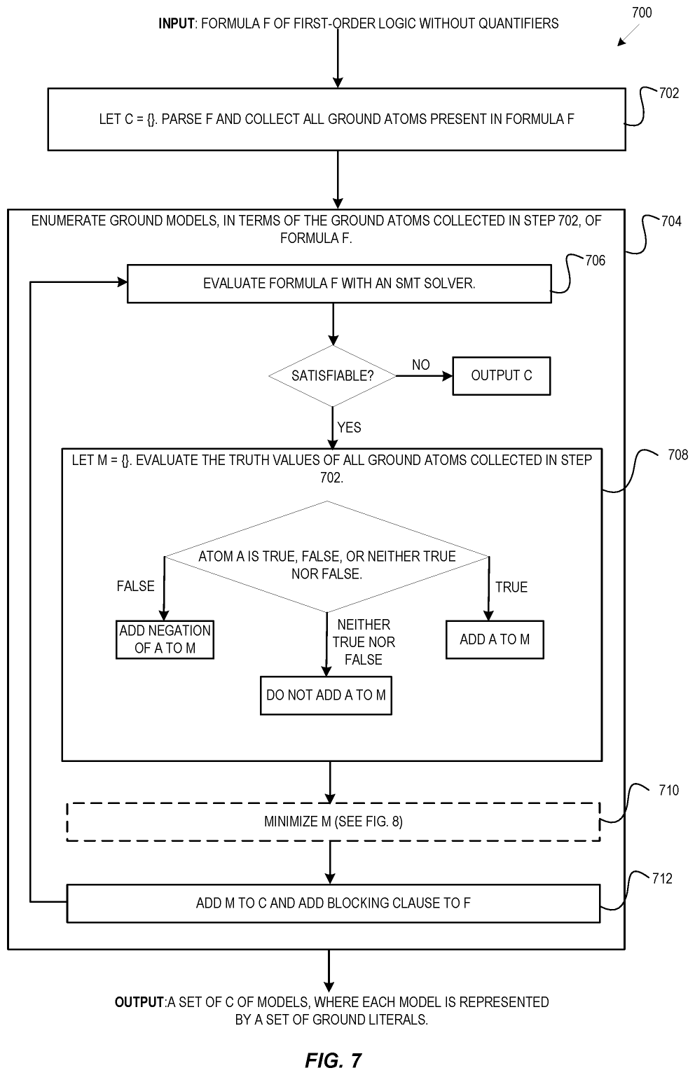

FIG. 7 is a flowchart 700 of an example method performed by the Enumerate Models procedure 602 (e.g., performed by the domain model creator system 116 in an implementation of the Enumerate Models procedure 602.) The input to the method is a formal F of first-order logic without quantifiers. The output of the method is a set C of models, where each model is represented by a set of ground literals.

At block 702, the set C is initialized to an empty set. The formula F is also parsed, and all ground atoms presented in F are collected. In the flowchart detailing the Enumerate Models procedure 602, block 702 represents the initial step of the process. At this stage, the set C, which is destined to hold the collection of models for the formula F, is initialized as an empty set. Concurrently, the procedure involves parsing the formula F. Parsing, in this context, means analyzing and breaking down the formula F into its constituent elements to understand its structure and content. Alongside the parsing of formula F, all ground atoms present in the formula are collected. Ground atoms are the basic building blocks in logical expressions, particularly in first-order logic. They are atomic formulas that do not contain any variables, which makes them definitive and concrete. By collecting all ground atoms from formula F, all the fundamental elements that are explicitly stated in the formula are gathered. These ground atoms are useful for constructing the models, as they represent the specific facts or propositions that need to be considered in any true interpretation of formula F.

At block 704, all ground models of formula F are enumerated in terms of the ground atoms collected at block 702. In this enumeration process, each ground model is constructed by considering various combinations and states (true or false) of the collected ground atoms. Since ground atoms are concrete and specific, lacking variables, they provide a finite and manageable set of elements with which to work. The procedure systematically explores every possible arrangement of these atoms to determine all the ways they can collectively satisfy formula F. This exhaustive approach ensures that no potential model is overlooked.

The goal of block 704 is to generate a comprehensive list of these ground models, each representing a unique way in which the formula F can be true. By the end of this block, the set C, initially empty, becomes populated with these models. Each model in set C is a distinct combination of ground atoms that aligns with the logical structure and requirements of formula F. This step is fundamental in understanding the full scope and implications of the formula, as it reveals every possible scenario under which the formula holds true, grounded in the specifics of the ground atoms identified earlier.

The enumeration of ground models of formula F can be accomplished in various ways. One way is depicted in FIG. 7. At block 706 in the Enumerate Models procedure 602, the process involves an evaluation phase using an SMT (Satisfiability Modulo Theories) solver. This step determines the viability of the models being generated. Here, the formula F, which has been broken down into its constituent ground atoms and used to construct potential models, is subjected to an analysis by the SMT solver. The SMT solver is a tool used in computational logic to determine the satisfiability of logical formulas, particularly those involving a combination of theories like arithmetic, bit-vectors, arrays, and others.

The primary task of the SMT solver is to assess whether the formula F is satisfiable (denoted as SAT)—that is, whether there exists at least one interpretation or model under which the formula can be considered true. If the SMT solver finds that the formula F is not satisfiable (denoted as UNSAT), it means there are no possible combinations of the ground atoms that would make the formula true. In this case, the procedure is halted, and the result is returned, indicating that no valid models exist for formula F within the parameters set by the ground atoms.

However, if the SMT solver determines that the formula F is satisfiable (denoted as SAT), it signifies that there are one or more models in which the formula holds true. In this scenario, the procedure advances to the next step, labeled as block 708, to continue the process of model enumeration.

At block 708 in the Enumerate Models procedure 602 follows the determination that the formula F is satisfiable (SAT), indicating the existence of at least one model that makes the formula true. At this stage, the procedure involves constructing a specific model M, which initially starts as an empty set. The focus here is on evaluating the truth values of all the ground atoms that were previously collected in block 702.

Each ground atom, being a fundamental element of the formula F, is assessed for its truth value in the context of the satisfiable formula F. The procedure dictates a systematic approach: if a ground atom is found to be true, it is added to the model M as is. This inclusion reflects that the atom, in its original form, is a part of the satisfying interpretation of formula F. Conversely, if a ground atom is evaluated as false, its negation is added to the model M. This step ensures that the model M accurately represents the state of each ground atom as it pertains to the satisfaction of formula F.

There's a third possibility where a ground atom may be neither definitively true nor false. In such cases, the procedure specifies that these atoms should not be added to the model M. By the end of block 708, the model M will have been populated with a combination of ground atoms and their negations, each reflecting its respective truth value, collectively forming a coherent model that satisfies the formula F.

Block 710 in the Enumerate Models procedure 602 represents an optional step aimed at optimizing the models generated. This step is focused on reducing the size and complexity of the model M, which was constructed in the previous block 708 based on the evaluation of ground atoms in the satisfiable formula F. The minimization is carried out according to the Minimize Model procedure 604.

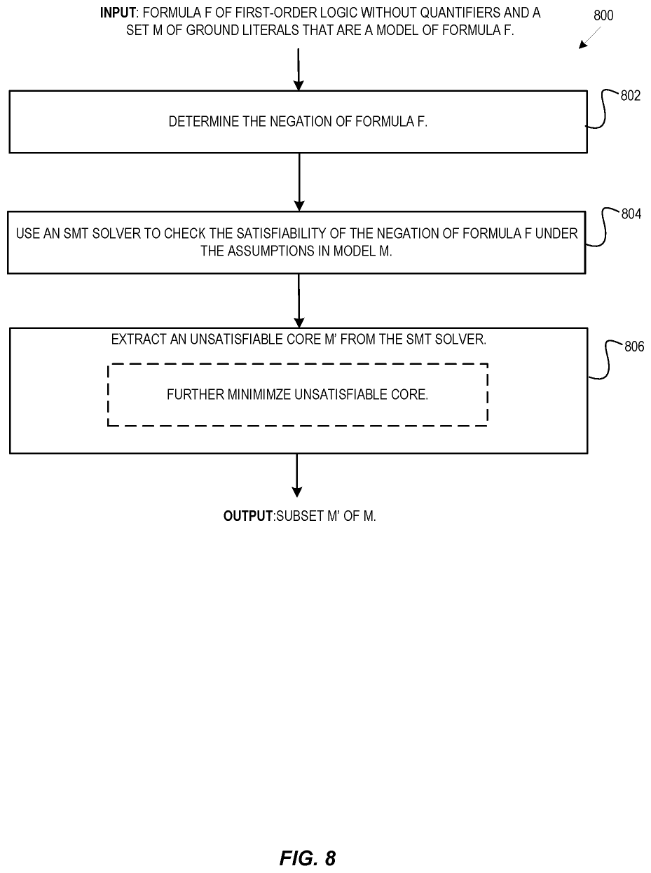

The Minimize Model procedure 604, as mentioned earlier and detailed further in the context of FIG. 8, is an approach to streamline a given model by eliminating any superfluous elements. This involves am examination of the model M to identify and remove any literals that are not essential for maintaining the truth of the formula F. The goal is to strip the model down to its most fundamental components, ensuring that it remains a valid interpretation of the formula while becoming more concise and manageable.

The optional nature of block 710 acknowledges that while minimization can enhance efficiency and clarity, it may not always be necessary or desirable depending on the specific objectives or constraints of the procedure. However, when employed, this step contributes to the utility and practicality of the models. A minimized model is easier to interpret and work with, especially in applications that require a clear understanding of the core conditions under which a formula is satisfied. Moreover, as minimized models are more general, minimizing models leads to fewer overall models, making it easier for humans to analyze them.

At block 712 in the Enumerate Models procedure 602, after the model M has been either directly derived or optionally minimized from the previous steps, it is added to the set C, which is the collective repository of all models generated for the formula F. This set C is intended to be a comprehensive collection of all possible interpretations or configurations that satisfy the formula, with each model representing a unique combination of literals that makes the formula true.

Also occurring at block 712 in the Enumerate Models procedure 602 is an important step that ensures the uniqueness of each model generated in the set C. In addition to adding the newly formed model M to set C, a ‘blocking clause’ is introduced into the formula F. This blocking clause is specifically designed to prevent the SMT solver, upon its next evaluation of formula F at block 708, from returning the same model M again.

The concept of a blocking clause is a strategic element in computational logic used to modify the formula F in a way that excludes the recently added model M from future considerations. Essentially, this clause adds a condition to formula F that is incompatible with the configuration of literals in model M. As a result, when the SMT solver re-evaluates formula F in subsequent iterations, it will be forced to explore different combinations of literals that lead to new models, different from model M. For example, the following equation represents the addition of a blocking clause for model M to formula F:

F:=F∧(V_{l∈M}¬l)

After adding the model M to set C and after adding the blocking clause for model M to formula F, the Enumerate Models procedure 602 returns to step 708 to evaluate the formula F again to determine if there any more models that satisfy the formula F. When all models that satisfy the formula F have been enumerated, then the Enumerate Models procedure 602 outputs the set C of models, where each model in the set C is represented by a set of ground literals.

FIG. 8 is a flowchart 800 of an example method performed by the Minimize Models procedure 604 (e.g., performed by the domain model creator system 116 in an implementation of the Minimize Models procedure 604.) The input to the method is a formal F of first-order logic without quantifiers and a set of M of ground literals that are a model of the formula F. The output of the method is a subset M′ of M.

The primary goal of the Minimize Models procedure 604 is to produce a subset M′ of M. This subset M′ is the most reduced or minimized version of M that still satisfies the formula F. In other words, M′ is the essential core of M, stripped of any literals that are not necessary for maintaining the truth of formula F. The process to achieve this involves systematically evaluating each literal in M to determine its necessity. Literals that are found to be superfluous—those that can be removed without altering the truth value of formula F—are discarded. The result of this procedure, the subset M′, is useful because it represents the most succinct and efficient version of the original model M while still being a valid model of formula F.

At block 802, a step involves determining the negation of the formula F. Formula F, initially formulated in first-order logic without quantifiers, represents a specific logical statement or set of statements. A new formula is created that is the logical inverse of formula F. In practical terms, this means applying a negation operator to formula F, thereby generating a formula that would be true in exactly those cases where formula F is false.

At block 804 of the Minimize Models procedure 604, an SMT (Satisfiability Modulo Theories) solver is used to check the satisfiability of the negation of formula F under the assumptions of model M. Model M, as established earlier, is a set of ground literals that collectively satisfy the original formula F. In this block, the task is to assume that each of the literals in M is true and then evaluate the negation of formula F under these assumptions.

Since M is a model of formula F, setting the literals in M to be true makes formula F true. Consequently, under these conditions, the negation of formula F should be false. This is because the negation of formula F represents a logical contradiction of formula F. Thus, when the literals of M (which make formula F true) are assumed to be true, the negation of F becomes inherently unsatisfiable (UNSAT).

The SMT solver's role here is to formally verify this logical conclusion. By checking the satisfiability of the negated formula F under the assumptions of M being true, the solver is expected to return an UNSAT result, confirming that these assumptions indeed make the negation of F false. This step is guaranteed to yield an UNSAT outcome due to the logical relationship between formula F, its negation, and the model M. This verification is useful as it reinforces the validity of model M as a true representation of formula F and sets the stage for further minimization of M.

At block 806 in the Minimize Models procedure 604, an unsatisfiable core, denoted as M′, is extracted from the SMT (Satisfiability Modulo Theories) solver. The unsatisfiable core M′ refers to a specific subset of the original model M. It represents the minimal set of ground literals from M that, when assumed to be true, render the negation of formula F unsatisfiable (UNSAT). In simpler terms, M′ contains only those literals that are absolutely necessary to maintain the truth of formula F.

The extraction of M′ is based on the outcome of the SMT solver's evaluation at the previous step (block 804), where the solver confirmed that the negation of formula F is unsatisfiable under the assumptions made by model M. The unsatisfiable core M′ is essentially the “core” of this unsatisfiability; it's the smallest collection of literals from M that still ensures the negation of F is false. This means that by setting the literals in M′ to be true, formula F is guaranteed to be true as well, confirming that M′ is indeed a valid model of formula F.

In an optional extension of the Minimize Models procedure 604, the unsatisfiable core M′, extracted in block 806, can be subjected to further minimization. This additional step involves an iterative process of selectively removing literals from the unsatisfiable core and then re-testing the satisfiability of the negation of formula F under these modified conditions. The aim here is to refine M′ to its absolute minimal form while ensuring that it remains a valid model of formula F.

The procedure starts by assuming a subset of M′ (with one or more literals removed) as true, and then checking whether the negation of formula F remains unsatisfiable (UNSAT) under this assumption. The SMT solver is used to evaluate the satisfiability each time a literal is removed. If, after the removal of a literal, the solver still returns UNSAT, it indicates that the removed literal was not essential for the truth of formula F, and thus can be permanently excluded from the core M′. This process is repeated iteratively, with different literals being removed and tested in each cycle.

The goal of this optional step is to strip down the unsatisfiable core to its most fundamental constituents, removing any literals that are not strictly necessary to maintain the unsatisfiability of the negation of F. It can be important to balance the benefits of further minimization with the computational overhead of repeated satisfiability testing. Each iteration requires computational resources, and there may be diminishing returns in terms of the simplification achieved. Therefore, the decision to undertake this additional minimization step might depend on the specific requirements and constraints of the application at hand.

As mentioned, the output of the method is a subset M′ of M.

The input to the Translate Models procedure 606 is a set C of models, where each model is represented by a set of ground literals. Ground literals are the fundamental components of these models; they are essentially atomic propositions or their negations, defined without the use of variables. This means that each ground literal represents a specific, concrete fact or statement within the logical framework of the model.

The models in set C have been derived from a logical formula, and each model presents a unique combination of ground literals that collectively satisfy the formula. The representation of models using ground literals is useful as it provides a clear and unambiguous framework for each model.

The translation process involves interpreting each model's combination of ground literals and articulating it in a comprehensible, narrative form. This is a useful step in making the logical implications of the models accessible to those who may not have expertise in formal logic. By translating these models into natural language, the procedure effectively bridges the gap between the abstract, formal world of logic and the more intuitive realm of human language and understanding.

The Translate Models procedure 606 culminates in producing a set N, which encompasses natural language texts. Each text within this set N corresponds to and describes one of the models from the input set C. The transformation from a model in C, represented initially by a set of ground literals in a formal logical structure, to a comprehensible piece of natural language text in N, is the essence of this procedure. The process involves interpreting each model—a specific combination of ground literals that collectively satisfy a logical formula—and then articulating it in a way that is easily understandable in everyday language.

In some embodiments, of the Translate Models procedure 606, the translation of models from logical language to natural language is facilitated using a Large Language Model (LLM). The LLM, with its advanced capabilities in understanding and generating natural language, serves as a useful tool for converting structured, formal language of logic into comprehensible, everyday language. To enhance the reliability and accuracy of these translations, a back translation technique is employed.

Back translation involves a two-step verification process. First, the LLM translates a model, represented by a set of ground literals, into a natural language text. This text is intended to accurately reflect the logical structure and implications of the original model. However, to validate the correctness of this translation, the procedure then involves translating this natural language text back into logical language, essentially reconstructing a logical model from the translated text.

This verification includes comparing the newly reconstructed logical model with the original model. If the two models are equivalent, it strongly suggests that the natural language translation accurately captured the essence of the original logical model. On the other hand, if there are discrepancies between the original and back-translated models, it flags a potential error in the translation. This discrepancy indicates that the natural language text may not have correctly or completely represented the logical intricacies of the original model.

This method of back translation provides an increased level of confidence in the accuracy of the natural language translations produced by the LLM. This technique adds a layer of validation, ensuring that the translations are not just linguistically fluent, but also logically faithful to the original models.

### Detecting and Explaining Inconsistencies in Text Via Minimal Unsatisfiable Cores

Specifications that are not fully formal, such as those written in natural language or those containing a mix of natural language and semi-formal elements like tables, can often contain inconsistencies that are not immediately apparent. The nature of natural language, with its inherent ambiguities, nuances, and variability in expression, can lead to unclear or contradictory statements within these specifications. When specifications are drafted in natural language, they are subject to various interpretations, and the lack of a strict formal structure makes it challenging to pinpoint inconsistencies.

Similarly, specifications that combine natural language with semi-formal elements like tables or diagrams introduce another layer of complexity. The integration of these different forms of expression can lead to misalignments or contradictions between what is stated in the text and what is represented in the tables or diagrams. These discrepancies might not be readily noticeable, especially if each component seems internally consistent when viewed in isolation.

The detection of inconsistencies in such mixed or informal specifications requires a careful and thorough examination, often demanding expert review or the use of specialized analytical tools. Unlike fully formal specifications, which are structured in a precise and unambiguous language that computers can process and verify, natural language and semi-formal specifications lack this level of clarity and formal structure. This absence of a strict formal framework means that inconsistencies can remain hidden or overlooked, posing challenges for accurate interpretation and application of the specifications. In fields where precision and consistency are vital, such as engineering, software development, and legal documentation, these hidden inconsistencies can lead to significant issues, making it imperative to approach these specifications with a heightened level of scrutiny.

In some embodiments, to address the challenge of detecting and explaining inconsistencies in specifications that are not fully formal, such as those written in natural language or containing a mix of semi-formal elements, a Large Language Model (LLM) is used. The LLM is employed to translate these complex specifications into a more structured form, specifically into a formula of first-order logic. This translation converts the ambiguities and variances of natural language into a precise, formal logical representation. By doing so, the LLM provides a clear and unambiguous foundation for further analysis.

Once the specifications are translated into a formula of first-order logic, an SMT (Satisfiability Modulo Theories) solver is then utilized to assess the consistency of this formula. The SMT solver is a powerful tool in computational logic, designed to determine the satisfiability of logical formulas, especially those involving complex combinations of theories. In this context, checking for satisfiability essentially means verifying whether the translated logical formula can be true under any possible interpretation. If the SMT solver finds the formula to be satisfiable, it indicates that the specifications are logically consistent; there are no internal contradictions or conflicts within the specified conditions.

However, if the SMT solver determines that the formula is unsatisfiable, it signals the presence of inconsistencies within the original specifications. These inconsistencies might be due to contradictory statements, conflicting requirements, or logical impossibilities inherent in the natural language or semi-formal elements of the specifications. By translating these specifications into first-order logic and employing an SMT solver for consistency checks, it becomes possible to detect and elucidate these hidden inconsistencies.

In some embodiments, if the SMT (Satisfiability Modulo Theories) solver returns an UNSAT (unsatisfiable) result while analyzing a specification translated into first-order logic, the procedure then focuses on identifying and explaining the source of this inconsistency. To do this, an unsatisfiable core is extracted from the formula. This unsatisfiable core is essentially a sub formula within the larger logical representation that is, by itself, unsatisfiable or inconsistent. It represents the specific part or aspect of the original specification that is causing the logical conflict or contradiction.

Once this unsatisfiable core is identified, it may be further minimized to distill it down to its most essential elements. This minimization process strips away any parts of the sub formula that are not directly contributing to the unsatisfiability, resulting in a more concise and focused representation of the inconsistency. This streamlined unsatisfiable core is crucial for providing a clear and understandable explanation of the inconsistency.

The next step involves translating this minimized unsatisfiable core back into natural language. This translation is aimed at making the technical and logical findings accessible and comprehensible to customers or end-users, who may not be familiar with the complexities of formal logic. The goal is to present them with a clear, concise explanation of why their specification is inconsistent, pinpointing the exact issue in a way that is easy to understand.

For example, consider a case of inconsistent zoning laws. Assume a corpus of zoning laws that govern under which conditions an accessory dwelling unit (ADU) can be built on a site. For example, in addition other rules, the zoning laws contain the following statements:
Statement E1: Properties with a lot size under 7,500 square feet cannot have an ADU.
Statement E2: Properties with a primary residence and a lot size of at least 7,500 square feet can build one ADU.
Statement E3: Properties within 500 feet of a public transportation stop can construct one ADU.

The above three statements are inconsistent because Statement E1 and Statement E3 contradict each other. Statement E1 states that properties with a lot size under 7,500 square feet cannot have an ADU whereas Statement E3 states that properties within 500 feet of a public transportation stop can construct an ADU, regardless of the property size.

The above statements can be translated to first-order logic in various ways. For example, the above three statements can be translated to the following first-order logic statements (formulas):
Formula E1: lotSize(property)<7500→-canHaveADU(property)
Formula E2: primaryResidence(property)∧lotSize(property)≥7500→canHaveADU(property)
Formula E3: distanceToPublicTransportationStop(property)≤500→canHaveADU(property)

This type of translation can be accomplished in various ways. For example, natural language statements can be multi-translated to first-order logic formulas using one or more large language models (LLMs) and then selecting a translation according to the unanimous or majority approaches discussed above with respect to equivalence checking for translations from natural language to formal logic.

### The Auto Model Method

In certain embodiments, an “auto model” approach is utilized, which combines Large Language Models (LLMs) with knowledge graphs. This combination presents a useful tool for customers seeking to develop and expand their domain logic models 118. The auto model technique automatically and iteratively refines the process of extending domain logic models, thereby progressively encompassing a broader scope of the customer's desired domain.

When combined, LLMs can leverage the structured data within knowledge graphs to make informed and contextually relevant suggestions for extending the domain logic models. This process is iterative, allowing for continuous refinement and expansion. As the model grows and evolves, the LLM can continually reassess and propose further enhancements, guided by the evolving knowledge graph. This iterative loop enables the domain logic model to become increasingly comprehensive, covering more aspects of the desired domain with each iteration.

The implementation of the auto model techniques offers a solution for enhancing the capabilities of the LLM verifier system 100, particularly in terms of validating answers generated by the vanilla LLM 102. Over time, as the auto model techniques are applied, they contribute to a significant reduction in instances where the LLM verifier system 100 cannot ascertain the validity or invalidity of an answer. This improvement stems from the dynamic and iterative nature of the auto model approach, which continuously refines and expands the underlying domain logic models 118.

The LLM verifier system 100 uses a vetted domain logic model 118 to validate answers generated by vanilla LLM 102. This validation can be relatively strict. For example, to classify an answer as valid, the LLM verifier system 100 may require that K|=¬A hold. Here, K represents the set of logical formulas (assertions) of the domain logic model 118 and ¬A represents the negation of the formal logic translation of the answer generated by the vanilla LLM 102 in response to a query Q submitted by the customer 102 to the vanilla LLM 102. The LLM verifier system 100 can determine whether this property holds by using a SMT solver (or another suitable automated theorem prover) to determine whether K∧¬A is unsatisfiable. If K∧¬A is unsatisfiable, then there is no assertion in K that affirmatively contradicts the answer and thus the answer is deemed valid. If K∧¬A is satisfiable, there is at least one assertion (called a witness) that contradicts the answer and thus the answer is not valid.

To classify an answer as invalid, the LLM verifier system 100 may require that K|=CONV. Here, CONV represents the conversation between the customer 102 and the vanilla LLM 102 encompassing a query submitted to the vanilla LLM 102 and the answer generated by the vanilla LLM 102 in response to the query. The LLM verifier system 100 can determine whether this property holds by using a SMT solver (or another suitable automated theorem prover) to determine whether K∧Q∧A is unsatisfiable. Here, Q represents a formal logic translation of the natural language form of the query for which the vanilla LLM 102 generated the answer and A represents the formal logic translation of the natural language form of the answer generated by the vanilla LLM 102 in response to the query. If K∧Q∧A is unsatisfiable, there is no assertion in K that affirms that the query Q implies the answer A and thus the answer is invalid. If K∧Q∧A is satisfiable, then there is at least one assertion/witness that affirms that the query Q implies the answer A and thus the answer is not invalid.

As a result, an answer can be considered neither valid nor invalid if the domain logic model 118 (represented by K in the above examples) does not entirely cover the desired domain. This is a challenge because it is difficult to know in advance whether everything the domain is covered by the domain logic model 118, a customer may not be eager to invest the amount of time needed to ensure that the entire domain is covered, and a customer might incorrectly assume that certain parts of their domain can be left out of the model.

To address these challenges, in some embodiments, when a natural language conversation encompassing a question and an answer is obtained from the vanilla LLM 102. The LLM verifier system 100 attempts to classify the answer in the way described above. The classification can be valid, invalid, or ambiguous. As discussed above, the classification can be ambiguous if no agreement can be reached among the LLMs translating the answer to logic according to the technique described above for equivalence checking for translations from natural language to formal logic.

The classification can also be “it depends” when both K∧Q∧A and K∧¬A are satisfiable (or equivalently when both are unsatisfiable). In the “it depends” case, the LLM verifier system 100 augments the domain logic model 118 such that only one of these remains satisfiable and the other because unsatisfiable. Consequently, under the augmented domain logic model 118, the answer provided by the vanilla LLM 102 because either valid or invalid with a justification.

If the answer is already in the auto model knowledge graph, the needed augmentation is already present. Otherwise, the LLM verifier system 100 uses a large language model (LLM) plus retrieval augmented generation (RAG) to augment the auto model knowledge graph with logical statements until the verification of the answer is either ‘valid’ or ‘invalid’. The RAG system considers the source material used for constructing the deployed knowledge base to increase the likelihood of conforming to the desired model. The newly added statements are labeled in the knowledge graph with the source they are based on.

At some later point, the collection of statements that augment the vetted domain logic model 118 are presented to the domain expert 112 in the form of the scenarios described above. Once refined, the accepted scenarios become a part of the vetted domain logic model 118 and the rejected scenarios are discarded.

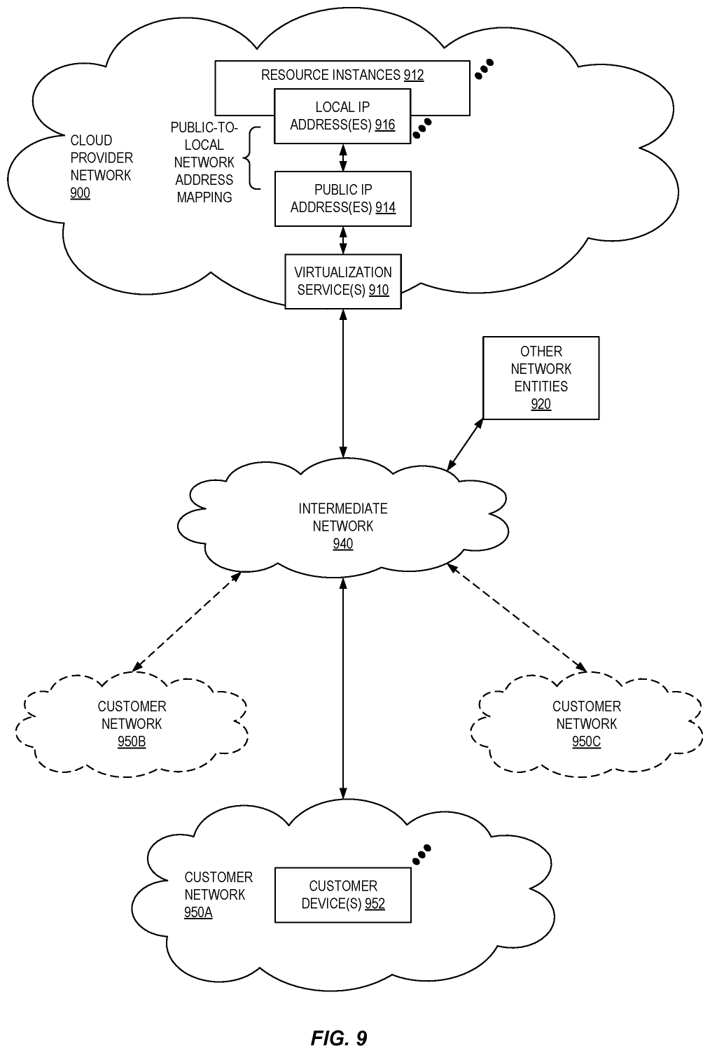

FIG. 9 illustrates an example multi-tenant provider network environment in which the techniques disclosed herein for large language model (LLM) verification. A provider network 900 can provide resource virtualization to customers via one or more virtualization services 910 that allow customers to purchase, rent, or otherwise obtain instances 912 of virtualized resources, including but not limited to computation and storage resources, implemented on devices within the provider network or networks in one or more data centers. Local Internet Protocol (IP) addresses 916 can be associated with the resource instances 912; the local IP addresses are the internal network addresses of the resource instances 912 on the provider network 900. In some examples, the provider network 900 can also provide public IP addresses 914 and/or public IP address ranges (e.g., Internet Protocol version 4 (IPv4) or Internet Protocol version 6 (IPv6) addresses) that customers can obtain from the provider network 900.

Conventionally, the provider network 900, via the virtualization services 910, can allow a customer of the service provider (e.g., a customer that operates one or more customer networks 950A-950C (or “client networks”) including one or more customer device(s) 952) to dynamically associate at least some public IP addresses 914 assigned or allocated to the customer with particular resource instances 912 assigned to the customer. The provider network 900 can also allow the customer to remap a public IP address 914, previously mapped to one virtualized computing resource instance 912 allocated to the customer, to another virtualized computing resource instance 912 that is also allocated to the customer. Using the virtualized computing resource instances 912 and public IP addresses 914 provided by the service provider, a customer of the service provider such as the operator of the customer network(s) 950A-950C can, for example, implement customer-specific applications and present the customer's applications on an intermediate network 940, such as the Internet. Other network entities 920 on the intermediate network 940 can then generate traffic to a destination public IP address 914 published by the customer network(s) 950A-950C; the traffic is routed to the service provider data center, and at the data center is routed, via a network substrate, to the local IP address 916 of the virtualized computing resource instance 912 currently mapped to the destination public IP address 914. Similarly, response traffic from the virtualized computing resource instance 912 can be routed via the network substrate back onto the intermediate network 940 to the source entity 920.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 900; a customer can then assign their allocated public IP addresses to particular resource instances allocated to the customer. These public IP addresses can be referred to as customer public IP addresses, or simply customer IP addresses. Instead of being assigned by the provider network 900 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

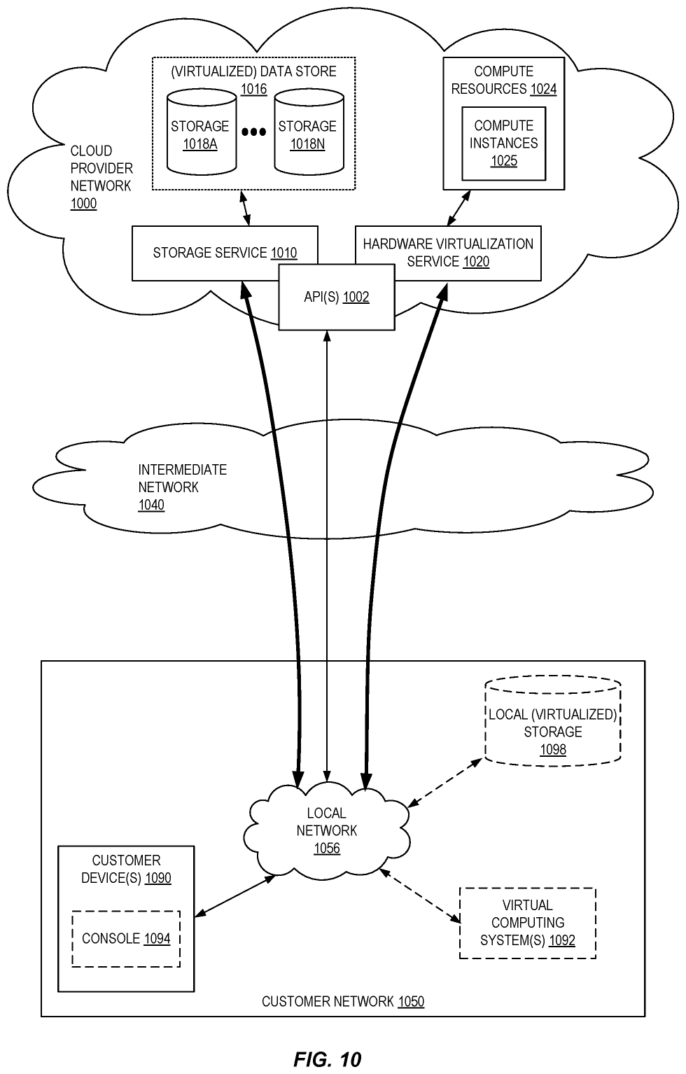

FIG. 10 is a block diagram of an example multi-tenant provider network that provides a storage service and a hardware virtualization service to customers and in which the techniques disclosed herein for large language model (LLM) verification. A hardware virtualization service 1020 provides multiple compute resources 1024 (e.g., compute instances 1025, such as VMs) to customers. The compute resources 1024 can, for example, be provided as a service to customers of a provider network 1000 (e.g., to a customer that implements a customer network 1050). Each computation resource 1024 can be provided with one or more local IP addresses. The provider network 1000 can be configured to route packets from the local IP addresses of the compute resources 1024 to public Internet destinations, and from public Internet sources to the local IP addresses of the compute resources 1024.

The provider network 1000 can provide the customer network 1050, for example coupled to an intermediate network 1040 via a local network 1056, the ability to implement virtual computing systems 1092 via the hardware virtualization service 1020 coupled to the intermediate network 1040 and to the provider network 1000. In some examples, the hardware virtualization service 1020 can provide one or more APIs 1002, for example a web services interface, via which the customer network 1050 can access functionality provided by the hardware virtualization service 1020, for example via a console 1094 (e.g., a web-based application, standalone application, mobile application, etc.) of a customer device 1090. In some examples, at the provider network 1000, each virtual computing system 1092 at the customer network 1050 can correspond to a computation resource 1024 that is leased, rented, or otherwise provided to the customer network 1050.

From an instance of the virtual computing system(s) 1092 and/or another customer device 1090 (e.g., via console 1094), the customer can access the functionality of a storage service 1010, for example via the one or more APIs 1002, to access data from and store data to storage resources 1018A-1018N of a virtual data store 1016 (e.g., a folder or “bucket,” a virtualized volume, a database, etc.) provided by the provider network 1000. In some examples, a virtualized data store gateway (not shown) can be provided at the customer network 1050 that can locally cache at least some data, for example frequently accessed or critical data, and that can communicate with the storage service 1010 via one or more communications channels to upload new or modified data from a local cache so that the primary store of data (the virtualized data store 1016) is maintained. In some examples, a user, via the virtual computing system 1092 and/or another customer device 1090, can mount and access virtual data store 1016 volumes via the storage service 1010 acting as a storage virtualization service, and these volumes can appear to the user as local (virtualized) storage 1098.

While not shown in FIG. 10, the virtualization service(s) can also be accessed from resource instances within the provider network 1000 via the API(s) 1002. For example, a customer, appliance service provider, or other entity can access a virtualization service from within a respective virtual network on the provider network 1000 via the API(s) 1002 to request allocation of one or more resource instances within the virtual network or within another virtual network.

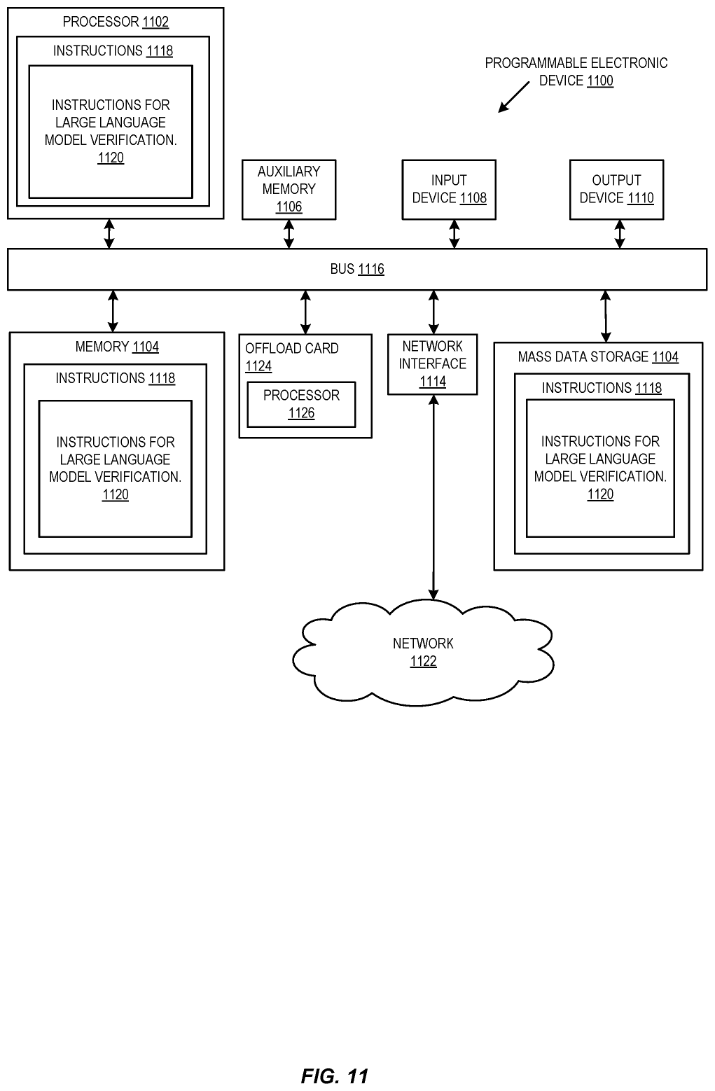

FIG. 11 illustrates an example of a programmable electronic device that processes and manipulates data to perform tasks and calculations disclosed herein for large language model (LLM) verification. Example programmable electronic device 1100 includes electronic components encompassing hardware or hardware and software including processor 1102, memory 1104, auxiliary memory 1106, input device 1108, output device 1110, mass data storage 1112, network interface 1114, and offload card 1124, all connected to bus 1116.

While only one of each type of component is depicted in FIG. 11 for the purpose of providing a clear example, multiple instances of any or all these electronic components may be present in device 1100. For example, multiple processors may be connected to bus 1116 in a particular implementation of device 1100. Accordingly, unless the context clearly indicates otherwise, reference with respect to FIG. 11 to a component of device 1100 in the singular such as, for example, processor 1102, is not intended to exclude the plural where, in a particular instance of device 1100, multiple instances of the electronic component are present. Further, some electronic components may not be present in a particular instance of device 1100. For example, device 1100 in a headless configuration such as, for example, when operating as a server racked in a data center, may not include, or be connected to, input device 1108 or output device 1110. As another example, offload card 1124 may be absent from device 1100 when not operating as a server racked in a data center as part of a cloud-based hosted compute service.

Processor 1102 is an electronic component that processes (e.g., executes, interprets, or otherwise processes) instructions 1118 including instructions 1120 for large language model (LLM) verification. Processor 1102 may perform arithmetic and logic operations dictated by instructions 1118 and coordinate the activities of other electronic components of device 1100 in accordance with instructions 1118. Processor 1102 may fetch, decode, and execute instructions 1118 from memory 1104. Processor 1102 may include a cache used to store frequently accessed instructions 1118 to speed up processing. Processor 1102 may have multiple layers of cache (L1, L2, L3) with varying speeds and sizes. Processor 1102 may be composed of multiple cores where each such core is a processor within processor 1102. The cores may allow processor 1102 to process multiple instructions 1118 at once in a parallel processing manner. Processor 1102 may support multi-threading where each core of processor 1102 can handle multiple threads (multiple sequences of instructions) at once to further enhance parallel processing capabilities. Processor 1102 may be made using silicon wafers according to a manufacturing process (e.g., 7 nm, 5 nm, or 3 nm). Processor 1102 can be configured to understand and execute a set of commands referred to as an instruction set architecture (ISA) (e.g., x86, x86_64, or ARM).

Depending on the intended application, processor 1102 can be any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other suitable type of CPU.

While processor 1102 can be a CPU, processor 1102, depending on the intended application, can be any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; specialized hardware for machine learning workloads, especially those involving tensors (multi-dimensional arrays); a field-programmable gate array (FPGA) or other reconfigurable integrated circuit that can be customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other suitable type of processor.

Memory 1104 is an electronic component that stores data and instructions 1118 that processor 1102 processes. Memory 1104 provides the space for the operating system, applications, and data in current use to be quickly reached by processor 1102. For example, memory 1104 may be a random-access memory (RAM) that allows data items to be read or written in substantially the same amount of time irrespective of the physical location of the data items inside memory 1104.

In some instances, memory 1104 is a volatile or non-volatile memory. Data stored in a volatile memory is lost when the power is turned off. Data in non-volatile memory remains intact even when the system is turned off. For example, memory 1104 can be Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. Memory 1104 can be Static RAM (SRAM). SRAM is volatile memory that is typically faster but more expensive than DRAM. SRAM uses multiple transistors for each memory cell but does not need to be periodically refreshed. Additionally, or alternatively, SRAM may be used for cache memory in processor 1102.

Device 1100 has auxiliary memory 1106 other than memory 1104. Examples of auxiliary memory 1106 include cache memory, register memory, read-only memory (ROM), secondary storage, virtual memory, memory controller, and graphics memory. Device 1100 may have multiple auxiliary memories including different types of auxiliary memories. Cache memory is found inside or very close to processor 1102 and is typically faster but smaller than memory 1104. Cache memory may be used to hold frequently accessed instructions 1118 (encompassing any associated data) to speed up processing. Cache memory may be hierarchical ranging from Level 1 cache memory which is the smallest but fastest cache memory and is typically inside processor 1102 to Level 2 and Level 3 cache memory which are progressively larger and slower cache memories that can be inside or outside processor 1102. Register memory is a small but very fast storage location within processor 1102 designed to hold data temporarily for ongoing operations. ROM is a non-volatile memory device that can only be read, not written to. For example, ROM can be a Programmable ROM (PROM), Erasable PROM (EPROM), or electrically erasable PROM (EEPROM). ROM may store basic input/output system (BIOS) instructions which help device 1100 boot up. Secondary storage is a non-volatile memory. For example, a secondary storage can be a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device. Virtual memory is a portion of a hard drive or an SSD that the operating system uses as if it were memory 1104. When memory 1104 gets filled, less frequently accessed data and instructions 1118 can be “swapped” out to the virtual memory. The virtual memory is slower than memory 1104, but it provides the illusion of having a larger memory 1104. A memory controller manages the flow of data and instructions 1118 to and from memory 1104. The memory controller can be located either on the motherboard of device 1100 or within processor 1102. Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 1108 is an electronic component that allows users to feed data and control signals into device 1100. Input device 1108 translates a user's action or the data from the external world into a form that device 1100 can process. Examples of input device 1108 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1110 is an electronic component that conveys information from device 1100 to the user or to another device. The information can be in the form of text, graphics, audio, video, or other media representation. Examples of an output device 1110 include a monitor or display device, a printer device, a speaker device, a headphone device, a projector device, a plotter device, a braille display device, a haptic device, a LED or LCD panel device, a sound card, and a graphics or video card.

Mass data storage 1112 is an electronic component used to store data and instructions 1118. Mass data storage 1112 may be non-volatile memory. Examples of mass data storage 1112 include a hard disk drive (HDD), a solid-state drive (SDD), an optical drive, a flash memory device, a magnetic tape drive, a floppy disk, an external drive, or a RAID array device. Mass data storage 1112 could additionally or alternatively be connected to device 1100 via network 1122. For example, mass data storage 1112 could encompass a network attached storage (NAS) device, a storage area network (SAN) device, a cloud storage device, or a centralized network filesystem device.

Network interface 1114 (sometimes referred to as a network interface card, NIC, network adapter, or network interface controller) is an electronic component that connects device 1100 to network 1122. Network interface 1114 functions to facilitate communication between device 1100 and network 1122. Examples of a network interface 1114 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1116 is an electronic component that transfers data between other electronic components of or connected to device 1100. Bus 1116 serves as a shared highway of communication for data and instructions (e.g., instructions 1118), providing a pathway for the exchange of information between components within device 1100 or between device 1100 and another device. Bus 1116 connects the different parts of device 1100 to each other. For example, bus 1116 may encompass one or more of: a system bus, a front-side bus, a data bus, an address bus, a control bus, an expansion bus, a universal serial bus (USB), a I/O bus, a memory bus, an internal bus, an external bus, and a network bus.

Instructions 1118 are computer-processable instructions that can take different forms. Instructions 1118 can be in a low-level form such as binary instructions, assembly language, or machine code according to an instruction set (e.g., x86, ARM, MIPS) that processor 1102 is designed to process. Instructions 1118 can include individual operations that processor 1102 is designed to perform such as arithmetic operations (e.g., add, subtract, multiply, divide, etc.); logical operations (e.g., AND, OR, NOT, XOR, etc.); data transfer operations including moving data from one location to another such as from memory 1104 into a register of processor 1102 or from a register to memory 1104; control instructions such as jumps, branches, calls, and returns; comparison operations; and specialization operations such as handling interrupts, floating-point arithmetic, and vector and matrix operations. Instructions 1118 can be in a higher-level form such as programming language instructions in a high-level programming language such as Python, Java, C++, etc. Instructions 1118 can be in an intermediate level form in between a higher-level form and a low-level form such as bytecode or an abstract syntax tree (AST).

Instructions 1118 for processing by processor 1102 can be in different forms at the same or different times. For example, when stored in mass data storage 1112 or memory 1104, instructions 1118 may be stored in a higher-level form such as Python, Java, or other high-level programing language instructions, in an intermediate-level form such as Python or Java bytecode that is compiled from the programming language instructions, or in a low-level form such as binary code or machine code. When stored in processor 1102, instructions 1118 may be stored in a low-level form such as binary instructions, assembly language, or machine code according to an instruction set architecture (ISA). However, instructions 1118 may be stored in processor 1102 in an intermediate level form or even a high-level form where CPU 1102 can process instructions in such form.

Instructions 1118 may be processed by one or more processors of device 1100 using different processing models including any or all of the following processing models depending on the intended application: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other suitable processing model.

Network 1122 is a collection of interconnected computers, servers, and other programmable electronic devices that allow for the sharing of resources and information. Network 1122 can range in size from just two connected devices to a global network (e.g., the internet) with many interconnected devices. Individual devices on network 1122 are sometimes referred to as “network nodes.” Network nodes communicate with each other through mediums or channels sometimes referred to as “network communication links.” The network communication links can be wired (e.g., twisted-pair cables, coaxial cables, or fiber-optic cables) or wireless (e.g., Wi-Fi, radio waves, or satellite links). Network 1122 may encompass network devices such as routers, switches, hubs, modems, and access points. Network nodes may follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol). Network 1122 may have a particular physical or logical layout or arrangement sometimes referred to as a “network topology.” Example network topologies include bus, star, ring, and mesh. Network 1122 can be different of different sizes and scopes. For example, network 1122 can encompass some or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

Device 1100 includes offload card 1124. Offload card 1124 includes its own processor 1126. Although not depicted in FIG. 1, offload card 1124 may also include network interface 1114. Offload card 1124 may be connected to bus 1116 via a Peripheral Component Interconnect-Express (PCI-E) standard or another suitable interconnect standard such as, for example, a QuickPath interconnect (QPI) standard or an UltraPath interconnect (UPI) standard. Device 1100 may include offload card 1124 when device 1100 acts as a host electronic device such as, for example, when operating as part of a hosted compute service. In this case, device 1100 hosts compute instances such as, for example, virtual machine instances or application container instances and offload card 1124 and processor 1126 run a hosted compute manager application that can manage the hosted compute instances that run on device 1100 and processor 1102. For example, the hosted compute manager application may perform hosted compute instance management operations, such as pausing or un-pausing hosted compute instances, launching or terminating hosted compute instances, performing memory transfer/copying operations, or other suitable hosted compute instance management operations. These management operations can, in some instances, be performed by the hosted compute manager application in coordination with a hypervisor (e.g., upon a request from the hypervisor) that runs on device 1100 and processor 1102. However, in some instances the hosted compute manager application is configured to process requests from other entities (e.g., from the hosted compute instances themselves), and does not coordinate with a hypervisor on device 1100.

### Terminology

As used herein and in the appended claims, the term “computer-readable media” refers to one or more mediums or devices that can store or transmit information in a format that a computer system can access. Computer-readable media encompasses both storage media and transmission media. Storage media includes volatile and non-volatile memory devices such as RAM devices, ROM devices, secondary storage devices, register memory devices, memory controller devices, graphics memory devices, and the like.

As used herein and in the appended claims, the term “non-transitory computer-readable media” as used herein encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Unless otherwise explicitly stated, the terms “set”, and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

As used herein, unless otherwise clear in context, the term “or” is open-ended and encompasses all possible combinations, except where infeasible. For example, if it is stated that a component may include A or B, then, unless infeasible or otherwise clear in context, the component may include at least A, or at least B, or at least A and B. As a second example, if it is stated that a component may include A, B, or C then, unless infeasible or otherwise clear in context, the component may include at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. can be either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
converting a set of natural language text documents into a domain logic model, the domain logic model comprising a set of first-order logic formulas;
enumerating a set of models of a first-order logic formula of the set of first-order logic formulas of the domain logic model;
minimizing a particular model of the set of models to yield a minimized model that replaces the particular model in the set of models;
translating the set of models comprising the minimized model to a set of natural-language texts;
providing the set of natural-language texts in a graphical user interface;
obtaining a conversational text, the conversational text comprising a query of a first large language model and an answer generated by the first large language model in response to the query;
using the conversational text to obtain a first-order logic translation of the answer from a second large language model;
determining whether the first-order logic translation of the answer is valid based on using a satisfiability modulo theories solver to determine whether a first query comprising a negation of the first-order logic translation of the answer is unsatisfiable; and
determining whether the first-order logic translation of the answer is invalid based on using a satisfiability modulo theories solver to determine whether a second query comprising the first-order logic translation of the answer is unsatisfiable; and
outputting an indication of whether the answer is valid, invalid, or neither valid nor invalid to a graphical user interface, a database, or a report.

2. The method of claim 1, further comprising:
using the conversational text to obtain a plurality of first-order logic translations of the answer from one or more large language models; wherein the plurality of first-order logic translations comprises the first-order logic translation; and wherein the one or more large language models comprises the first large language model;
partitioning the plurality of first-order logic translations of the answer based on logical equivalence with respect to the set of first order logical formulas of the domain logic model into one or more non-overlapping sets of the plurality of first-order logic translations; and
selecting the first-order logical translation of the answer from the one or more non-overlapping sets of the plurality of first-order logical translations.

3. The method of claim 1,
translating the set of natural-language statements into a plurality of first-order logic formulas; and
using a satisfiability modulo theories solver to extract an unsatisfiable core formula from the plurality of first-order logic formulas;
translating the unsatisfiable core formula to a natura-language text; and
providing the natural-language text in a graphical user interface.

4. A method for large language model verification comprising:
obtaining a conversational text, the conversational text comprising a query of a first large language model and an answer generated by the first large language model in response to the query;
using the conversational text to obtain a first-order logic translation of the answer from a second large language model;
determining whether the first-order logic translation of the answer is valid based on using an automated theorem prover to determine whether a first query comprising a negation of the first-order logic translation of the answer is unsatisfiable; and
determining whether the first-order logic translation of the answer is invalid based on using an automated theorem prover to determine whether a second query comprising the first-order logic translation of the answer is unsatisfiable; and
outputting an indication of whether the answer is valid, invalid, or neither valid nor invalid to a graphical user interface, a database, or a report.

5. The method of claim 4, further comprising:
using the conversational text to obtain a plurality of first-order logic translations of the answer from one or more large language models; wherein the plurality of first-order logic translations comprises the first-order logic translation; and wherein the one or more large language models comprises the first large language model;
partitioning the plurality of first-order logic translations of the answer based on logical equivalence with respect to the set of first order logical formulas of the domain logic model into one or more non-overlapping sets of the plurality of first-order logic translations; and
selecting the first-order logical translation of the answer from the one or more non-overlapping sets of the plurality of first-order logical translations.

6. The method of claim 5, wherein selecting the first-order logical translation of the answer from the one or more non-overlapping sets of the plurality of first-order logical translations is based on:
identifying a non-overlapping set of the one or more non-overlapping sets that comprises all of the plurality of first-order logic translations; and
selecting the first-order logic translation from the non-overlapping set.

7. The method of claim 5, wherein selecting the first-order logical translation of the answer from the one or more non-overlapping sets of the plurality of first-order logical translations is based on:
identifying a non-overlapping set of the one or more non-overlapping sets that comprises more than half of the plurality of first-order logic translations; and
selecting the first-order logic translation from the non-overlapping set.

8. The method of claim 4, further comprising:
converting a set of natural language text documents into the set of first-order logic formulas of the domain logic model.

9. The method of claim 4, further comprising:
enumerating a set of models of a first-order logic formula of the set of first-order logic formulas of the domain logic model;
minimizing a particular model of the set of models to yield a minimized model that replaces the particular model in the set of models;
translating the set of models comprising the minimized model to a set of natural-language texts; and
providing the set of natural-language texts in a graphical user interface.

10. The method of claim 4, further comprising:
translating a set of natural-language statements into a plurality of first-order logic formulas; and
using an automated theorem prover to extract an unsatisfiable core formula from the plurality of first-order logic formulas;
translating the unsatisfiable core formula to a natura-language text; and
providing the natural-language text in a graphical user interface.

11. The method of claim 4, wherein:
the first query comprises is unsatisfiable;
the second query is satisfiable;
the indication output indicates that the answer is valid.

12. The method of claim 4, further comprising:
the first query is satisfiable;
the second query is unsatisfiable;
the indication output indicates that the answer is invalid.

13. The method of claim 4, further comprising:
the first query is satisfiable;
the second query is satisfiable; and
the indication output indicates that the answer is neither valid nor invalid.

14. A system comprising:
a first one or more programmable electronic devices to implement an automated theorem prover; and
a second one or more programmable electronic devices to implement a large language model verification system, the large language model verification system comprising instructions which when executed cause the large language model verification system to perform:
obtaining a conversational text, the conversational text comprising a query of a first large language model and an answer generated by the first large language model in response to the query;
using the conversational text to obtain a first-order logic translation of the answer from a second large language model;
determining whether the first-order logic translation of the answer is valid based on using an automated theorem prover to determine whether a first query comprising a negation of the first-order logic translation of the answer is unsatisfiable; and
determining whether the first-order logic translation of the answer is invalid based on using an automated theorem prover to determine whether a second query comprising the first-order logic translation of the answer is unsatisfiable; and
outputting an indication of whether the answer is valid, invalid, or neither valid nor invalid to a graphical user interface, a database, or a report.

15. The system of claim 14, wherein the large language model verification system further comprises instructions which when executed cause the large language model verification system to perform:
using the conversational text to obtain a plurality of first-order logic translations of the answer from one or more large language models; wherein the plurality of first-order logic translations comprises the first-order logic translation; and wherein the one or more large language models comprises the first large language model;
partitioning the plurality of first-order logic translations of the answer based on logical equivalence with respect to the set of first order logical formulas of the domain logic model into one or more non-overlapping sets of the plurality of first-order logic translations; and
selecting the first-order logical translation of the answer from the one or more non-overlapping sets of the plurality of first-order logical translations.

16. The system of claim 15, wherein selecting the first-order logical translation of the answer from the one or more non-overlapping sets of the plurality of first-order logical translations is based on:
identifying a non-overlapping set of the one or more non-overlapping sets that comprises all of the plurality of first-order logic translations; and
selecting the first-order logic translation from the non-overlapping set.

17. The system of claim 15, wherein selecting the first-order logical translation of the answer from the one or more non-overlapping sets of the plurality of first-order logical translations is based on:
identifying a non-overlapping set of the one or more non-overlapping sets that comprises more than half of the plurality of first-order logic translations; and
selecting the first-order logic translation from the non-overlapping set.

18. The system of claim 14, wherein the large language model verification system further comprises instructions which when executed cause the large language model verification system to perform:
converting a set of natural language text documents into the set of first-order logic formulas of the domain logic model.

19. The system of claim 14, wherein the large language model verification system further comprises instructions which when executed cause the large language model verification system to perform:
enumerating a set of models of a first-order logic formula of the set of first-order logic formulas of the domain logic model;
minimizing a particular model of the set of models to yield a minimized model that replaces the particular model in the set of models;
translating the set of models comprising the minimized model to a set of natural-language texts; and
providing the set of natural-language texts in a graphical user interface.

20. The system of claim 14, wherein the large language model verification system further comprises instructions which when executed cause the large language model verification system to perform:
translating a set of natural-language statements into a plurality of first-order logic formulas; and
using an automated theorem prover to extract an unsatisfiable core formula from the plurality of first-order logic formulas;
translating the unsatisfiable core formula to a natura-language text; and
providing the natural-language text in a graphical user interface.
